(19) United States
(12) Patent Application Publication
(10) Pub. No.: US 2026/0084844 A1
(43) Pub. Date: Mar. 26, 2026

(54) Drone server for atmospheric and water environment inspection and its control method

(71) Applicant: Dong-A University Research Foundation For Industry-Academy Cooperation, Busan (KR)

(72) Inventor: Yong Suk KIM, Busan (KR)

(21) Appl. No.: 19/088,964

(22) Filed: Mar. 24, 2025

(30) Foreign Application Priority Data
Sep. 23, 2024 (KR) 10-2024-0128474

(51) Int. Cl. B64U 20/87; G06V 20/56; H04W 4/40

(52) U.S. Cl. CPC B64U 20/87; G06V 20/56; H04W 4/40

(57) ABSTRACT

Provided are a drone server for atmospheric and water environment inspection and a method for controlling the same, and more specifically, to a drone server for atmospheric and water environment inspection, which is installed on an environmental inspection drone for atmospheric and water environment inspection to control the environmental inspection drone and perform atmospheric and water environment inspection, and a method for controlling the same. In order to achieve the above object of the present invention, a drone server and a method of controlling this for atmospheric and water environmental inspection is provided.

### TECHNICAL FIELD

The present invention relates to a drone server for atmospheric and water environment inspection and a method for controlling the same, and more specifically, to a drone server for atmospheric and water environment inspection, which is installed on an environmental inspection drone for atmospheric and water environment inspection to control the environmental inspection drone and perform atmospheric and water environment inspection, and a method for controlling the same.

### BACKGROUND ART

Drones are being widely used to inspect the environment recently. Drones inspecting the environment can quickly collect precise data even in areas that are difficult for humans to access (for example, environmental data can be safely obtained through drones in mountainous or polluted areas), and can automatically fly along preset routes to collect data, reducing manpower consumption and maintaining consistency in data collection. They can be used in various environmental fields such as measuring fine dust in the air, testing water quality, and monitoring soil pollution, allowing for more effective management of various environmental issues. Drones can also be used to collect environmental data in areas that are dangerous to humans, ensuring safety while obtaining necessary information. In addition, they can survey a wide area in a short period of time without mobilizing manpower and equipment, reducing costs compared to traditional methods, and thus have high utility value.

However, in order to inspect the air and water environment, an environmental inspection drone specialized in the air and water environment is required. A drone for air and water environment inspection and a control method thereof are required, which includes various sensors that can accurately monitor and analyze the air and water environment, can save the battery and time required for air and water environment inspection, can analyze various chemical and physical characteristics of air quality and water quality, and can adjust the inspection point interval, inspection time, and altitude according to external environmental factors, and as a result, can accurately measure and analyze the air and water conditions.

### PRIOR ART DOCUMENTS

### Patent Documents

Korean Patent Publication No. 10-2048796

### Description of the Invention

### Problem to be Solved

Accordingly, the technical problem of the present invention was conceived from this point, and the purpose of the present invention is to provide a drone server for atmospheric and water environment inspection capable of accurately monitoring and analyzing atmospheric and water environments, and a method for controlling the same.

In addition, it provides a drone server for atmospheric and water environment inspection including various sensors capable of accurately monitoring and analyzing atmospheric and water environments and a method for controlling the same.

In addition, a drone server and a control method thereof for air and water environment inspection are provided, which can adjust the interval of inspection points according to the air pollution level.

In addition, it provides a drone server and a control method for atmospheric and water environment inspection, which can adjust the inspection point interval, inspection time, and altitude according to various external environmental factors such as weather conditions, wind speed, and temperature.

In addition, a drone server and a control method thereof for air and water environment inspection that can accurately determine whether an abnormality has occurred in a set air and water environment inspection area are provided.

In addition, a drone server for air and water environment inspection and a control method thereof are provided, which can set an optimal environment inspection movement path in a set air and water environment inspection area.

In addition, it provides a drone server for air and water environment inspection and a control method thereof that can transmit and share data collected during air and water environment inspection to a central customs center.

### Means for Solving the Problem

In order to realize the above object of the present invention, a drone server for environmental inspection is provided, which is installed on an environmental inspection drone and includes an input unit for inputting external information into the server; an output unit for outputting information inside the server to the outside; a communication unit for communicating internal and external information of the server; a storage unit for storing information generated in the server; a sensor unit for detecting information inside and outside the server; a control unit for controlling all operations of the server; and a memory unit for executing various programs and storing data accompanying them, wherein the memory unit includes a position measuring unit for measuring the position of the environmental inspection drone, an inspection area setting unit for setting an inspection area of the environmental inspection drone, an inspection movement path setting unit for setting an inspection movement path of the environmental inspection drone, an inspection movement path storage unit for storing the inspection movement path set by the inspection movement path setting unit, an air environment inspection unit for inspecting the air environment, a water quality environment inspection unit for inspecting the water quality environment, and an abnormality occurrence inspection unit for inspecting whether an abnormality occurs during an environmental inspection.

### Effects of the Invention

According to the present invention, the air and water environment inspection drone can efficiently and accurately monitor and analyze the air and water environment. In particular, the air and water environment inspection drone can collect and analyze information on the air and water environment by utilizing various sensors equipped in the sensor section, thereby identifying and analyzing air and water quality in real time.

Additionally, air and water environment inspection drones can accurately analyze the location and severity of specific pollution sources as their atmospheric sensors can detect various types of pollutants.

In addition, the air and water environment inspection drone can maximize inspection efficiency by adjusting the interval between inspection points according to the air pollution level, conducting inspections more frequently to obtain precise data when the pollution level is high, and reducing the inspection frequency when the pollution level is low to save battery and inspection time.

In addition, air and water environment inspection drones can measure the concentration and distribution of air pollutants, analyze the direction and speed of the wind to track the location of the pollutant source, and thereby increase the possibility of tracing the source of air pollution.

In addition, the air and water environment inspection drone can adjust the inspection point interval, inspection time, and altitude according to various external environmental factors such as weather conditions, wind speed, and temperature, thereby providing a flexible inspection method tailored to the environment.

In addition, the air and water environment inspection drone can analyze environmental data collected in real time to adjust the inspection time interval, so that the inspection frequency can be efficiently managed by reducing the inspection interval when the pollution level is severe and increasing the interval when it is not.

In addition, air and water environment inspection drones can analyze water pollution status by analyzing water quality measurement sensors and various chemical and physical properties, and in particular, they can accurately identify water pollution status by visually analyzing the water status through precision equipment such as hyperspectral cameras.

In addition, the air and water environment inspection drone can shorten the environmental inspection time by setting an optimal environmental inspection movement path in the set environmental inspection area.

In addition, the air and water environment inspection drone can set an optimal environment inspection movement path in a set environment inspection area to minimize battery consumption required for environment inspection work.

Additionally, air and water environment inspection drones can transmit and share data collected during environmental inspections to the central customs center, allowing for accurate data to be collected and shared in real time.

In addition, it can accurately determine whether an abnormality has occurred in the set air and water environment inspection area, and transmit and share the occurrence of the abnormality to the central customs center.

However, the effects of the present invention are not limited to the above effects, and can be expanded in various ways without departing from the spirit and scope of the present invention.

### BRIEF DESCRIPTION OF THE DRAWINGS

FIG. 1 is a drawing showing an environmental inspection drone according to an embodiment of the present invention.

FIG. 2 is a block diagram of a drone server for environmental inspection installed in an environmental inspection drone according to an embodiment of the present invention.

FIG. 3 is a drawing showing that a plurality of environmental inspection drones for environmental inspection according to an embodiment of the present invention are integrated with each other or a central control center as a network.

FIG. 4 is a drawing showing that a plurality of environmental inspection drones for environmental inspection according to an embodiment of the present invention set an environmental inspection area.

FIG. 5 is a drawing showing that environmental inspection drones according to an embodiment of the present invention cooperate with each other to inspect an environmental inspection area.

FIG. 6 is a drawing showing that an environmental inspection drone according to an embodiment of the present invention sets a maximum area that can be inspected.

FIG. 7 is an enlarged view showing a camera sensor equipped in an environmental inspection drone according to an embodiment of the present invention.

FIG. 8 is a drawing showing an environmental inspection drone according to an embodiment of the present invention setting an inspection movement path to conduct an inspection within a set environmental inspection area.

FIG. 9 is a drawing showing an environmental inspection drone according to an embodiment of the present invention setting an inspection movement path in an n+1 inspection to conduct an inspection within a set environmental inspection area.

FIG. 10 is a drawing showing an environmental inspection drone according to an embodiment of the present invention and changing an inspection point according to a change in its surrounding situation.

FIG. 11 is a drawing showing an atmospheric environment inspection unit of an environmental inspection drone according to an embodiment of the present invention inspecting an atmospheric environment.

FIG. 12 is a drawing showing an atmospheric environment inspection unit of an environmental inspection drone according to an embodiment of the present invention setting an inspection point according to the direction of wind movement.

FIG. 13 is a drawing showing a water quality environment inspection unit of an environmental inspection drone according to an embodiment of the present invention inspecting a water quality environment.

FIG. 14 is a drawing showing a process of inspecting images captured by a camera sensor before and after an abnormality occurs in an abnormality occurrence inspection unit of an environmental inspection drone according to an embodiment of the present invention.

FIG. 15 is a drawing showing a process of comparing and analyzing a current image captured by a camera sensor of an environmental inspection drone according to an embodiment of the present invention with a past image stored in a storage unit to determine whether an abnormality occurs and the cause of the abnormality.

FIG. 16 is a drawing showing a process of dividing a current image captured by a camera sensor of an environmental inspection drone according to an embodiment of the present invention into details and then comparing and analyzing the past images stored in a storage unit to determine whether an abnormality occurs and the cause of the abnormality.

FIG. 17 is a drawing showing a process of setting and correcting an inspection location for an environmental inspection drone according to an embodiment of the present invention.

### DETAILED DESCRIPTION FOR IMPLEMENTING THE INVENTION

Hereinafter, preferred embodiments of the present invention will be described in more detail with reference to the drawings.

The present invention can be modified in various ways and can take various forms, and specific embodiments are illustrated in the drawings and described in detail in the text. However, this is not intended to limit the present invention to specific disclosed forms, but should be understood to include all modifications, equivalents, or substitutes included in the spirit and technical scope of the present invention.

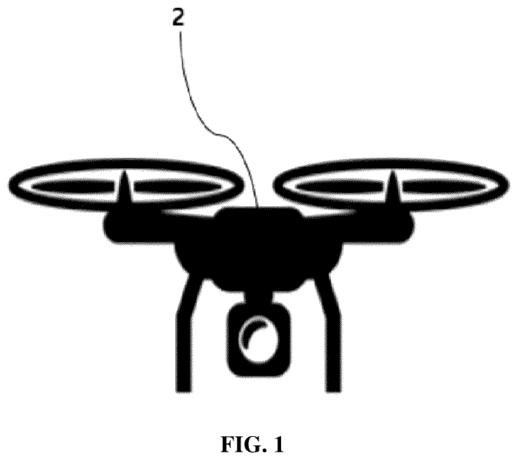

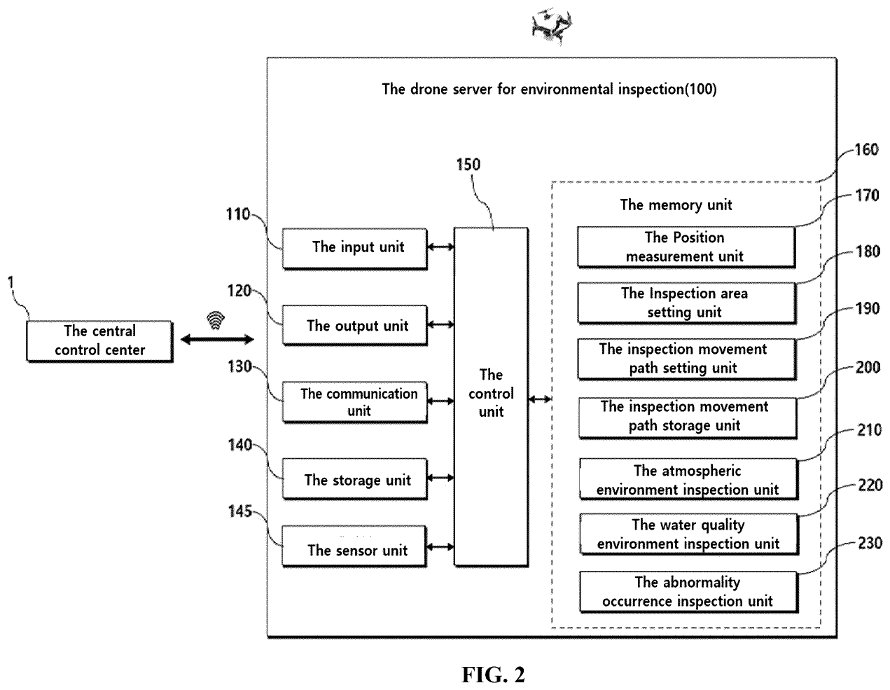

FIG. 1 is a drawing showing an environmental inspection drone according to an embodiment of the present invention, and FIG. 2 is a block diagram of a drone server for environmental inspection installed in an environmental inspection drone according to an embodiment of the present invention.

Referring to FIGS. 1 and 2, the drone server (100) for environmental inspection installed in the environmental inspection drone (2) of the present invention is composed of an input unit (110), an output unit (120), a communication unit (130), a storage unit (140), a sensor unit (145), a control unit (150), and a memory unit (160). The input unit (110) is responsible for inputting external information into the server, the output unit (120) is responsible for external output of internal information of the server, the communication unit (130) is responsible for communication of information inside and outside the server, the storage unit (140) is responsible for storing server information, the sensor unit (145) detects environmental information inside and outside the server, the control unit (150) is responsible for controlling all operations of the server, and the memory unit (160) is responsible for executing various programs and storing data accompanying them.

The sensor unit (145) may be equipped with a gyro/acceleration sensor, and the gyro/acceleration sensor maintains the balance of the environmental inspection drone (2) and measures its posture while moving. The gyro sensor measures rotational motion, and the acceleration sensor measures linear motion, and the gyro/acceleration sensor is used to ensure that the environmental inspection drone (2) moves stably without leaning to one side. In addition, the sensor unit (145) may be equipped with a compass sensor, and the compass sensor measures the magnetic north and transmits the direction information of the environmental inspection drone (2) to the control unit of the environmental inspection drone (2). It is equipped in an environmental inspection drone (2) with a GPS function and is used to maintain the directionality of the environmental inspection drone (2). In addition, the sensor unit (145) may be equipped with a GPS sensor, and the GPS sensor is used to allow the environmental inspection drone (2) to accurately determine its own location, set a movement path, and automatically return to the central control center (1). In addition, the sensor unit (145) may be equipped with an altitude sensor, and the altitude sensor is used for the environmental inspection drone (2) to accurately measure the height of its own location from the ground. In addition, the sensor unit (145) may be equipped with a camera sensor (40), and the camera sensor (40) is used for the environmental inspection drone (2) to take and transmit videos or photos in real time. Depending on how the environmental inspection drone (2) is used, various camera sensors (40) are used, from a high-resolution camera sensor to an infrared camera sensor. In addition, the sensor unit (145) may be equipped with a LiDAR sensor, and the LiDAR sensor is used for the environmental inspection drone (2) to scan the surrounding environment (e.g., surrounding terrain or obstacles) using a laser to avoid obstacles and recognize the terrain. In addition, the sensor unit (145) may be equipped with an ultrasonic sensor, and the ultrasonic sensor is used to measure the distance to an object using sound waves by the environmental inspection drone (2) and is used to measure the height for landing by the environmental inspection drone (2). In addition, the sensor unit (145) may be equipped with a temperature or humidity sensor, and the temperature or humidity sensor of the surrounding environment is used to monitor the temperature or humidity of the environment by the environmental inspection drone (2). In addition, the sensor unit (145) may be equipped with a wind direction and wind speed sensor, and the wind direction and wind speed sensor is used to measure the direction and speed of the wind when the environmental inspection drone (2) moves, and to adjust the movement path of the environmental inspection drone (2). In addition, the sensor unit (145) may be equipped with an atmospheric sensor, and the atmospheric sensor is used to measure the quality of the atmosphere by the environmental inspection drone (2). Additionally, the sensor unit (145) may be equipped with a water quality measurement sensor, and the water quality measurement sensor is used by the environmental inspection drone (2) to measure water quality.

In addition, the memory unit (160) includes a position measurement unit (170) that measures the position of the environmental inspection drone (2), an inspection area setting unit (180) that sets an inspection area for an environmental inspection of the environmental inspection drone (2), an inspection movement path setting unit (190) that sets an inspection movement path for the environmental inspection of the environmental inspection drone (2), an inspection movement path storage unit (200) that stores the inspection movement path along which the environmental inspection drone (2) moves for the environmental inspection when the environmental inspection drone (2) completes the environmental inspection while moving along the inspection movement path set by the inspection movement path setting unit (190), an air environment inspection unit (210) that inspects the air environment, a water quality environment inspection unit (220) that inspects the water quality environment, and an abnormality occurrence inspection unit (230) that inspects whether an abnormality occurs during the environmental inspection.

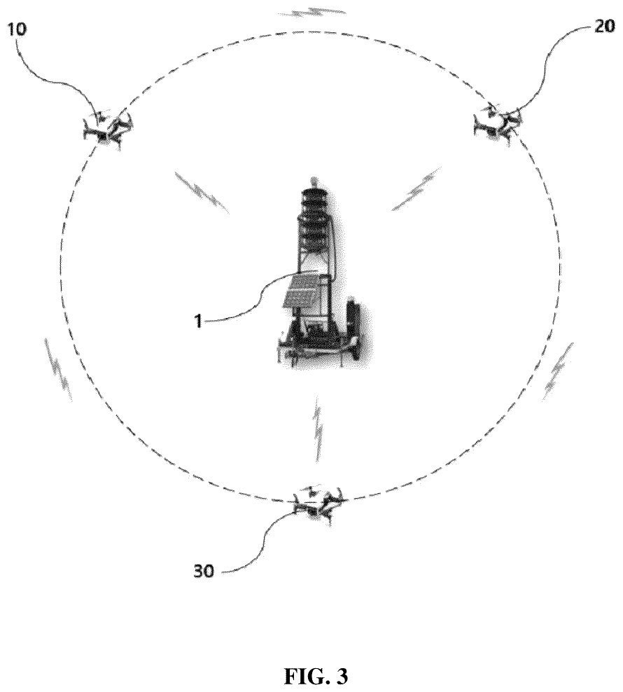

FIG. 3 is a diagram showing a plurality of environmental inspection drones for environmental inspection according to one embodiment of the present invention integrated into a network with each other or a central control center.

Referring to FIG. 3, the sensor unit (145) of the drone server (100) for environmental inspection installed in the first, second and third environmental inspection drones (10, 20, 30) measures the GPS coordinates (latitude and longitude coordinates) and altitude coordinates of the first, second and third environmental inspection drones (10, 20, 30) by utilizing the GPS sensor and altitude sensor provided in the sensor unit (145), and the location measuring unit (170) of the memory unit (160) of the drone server (100) for environmental inspection specifies the locations of the first, second and third environmental inspection drones (10, 20, 30) by utilizing the GPS coordinates (latitude and longitude coordinates) and altitude coordinate information measured from the sensor unit (145). In addition, the locations of the specified first, second and third environmental inspection drones (10, 20, 30) are shared among the environmental inspection drones (2) and also with the central control center (1). To this end, the first, second and third environmental inspection drones (10, 20, 30) are integrated into a mutual network, and the first, second and third environmental inspection drones (10, 20, 30) are also integrated into a network with the central control center (1).

The GPS sensor equipped in the sensor unit (145) of the drone server (100) for environmental inspection measures the coordinates of the horizontal plane of the environmental inspection drone (2) through an artificial satellite. The coordinates of the horizontal plane of the environmental inspection drone (2) are expressed in latitude and longitude, and through this, it is possible to determine where on the Earth the environmental inspection drone (2) is located. For example, in the case of the first environmental inspection drone (10), the location is measured and recorded in a manner such as latitude 37.7749 degrees north, longitude 122.4194 degrees west.

The altitude sensor equipped in the sensor unit (145) measures the altitude of the environmental inspection drone (2). The altitude sensor measures and indicates how high the environmental inspection drone (2) is from the ground surface, and measures altitude coordinates according to the distance from the ground surface using changes in air pressure or a laser. For example, if the first environmental inspection drone (10) is at a height of 150 meters, the altitude sensor can display the altitude coordinates as ‘altitude: 150 meters’.

The location information specified through the location measuring unit (170) of the first, second and third environmental inspection drones (10, 20, 30) is shared among the first, second and third environmental inspection drones (10, 20, 30) and transmitted to and shared with the central control center (1), so that the specific locations of the first, second and third environmental inspection drones (10, 20, 30) are identified in real time.

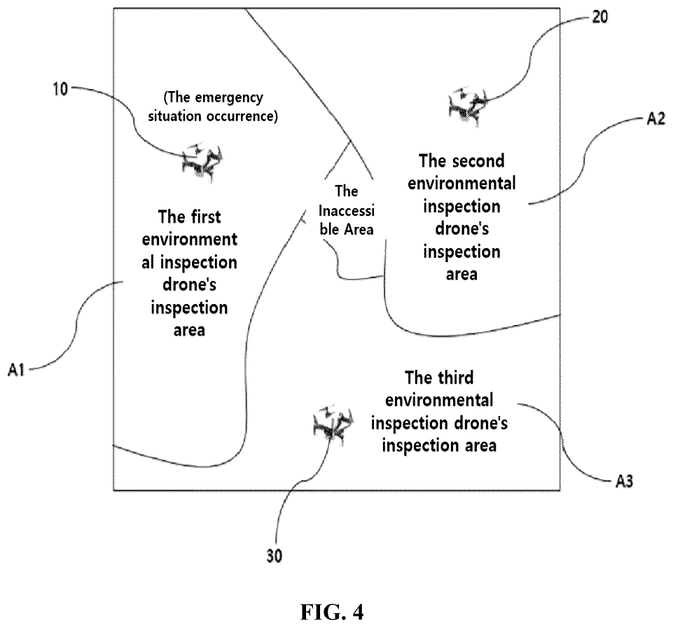

FIG. 4 is a drawing showing a plurality of environmental inspection drones setting an environmental inspection area for environmental inspection according to one embodiment of the present invention.

Referring to FIG. 4, the first environmental inspection drone (10), the second environmental inspection drone (20), and the third environmental inspection drone (30) each set an area to be inspected. The inspection area setting unit (180) of the memory unit (160) of each of the first environmental inspection drone (10), the second environmental inspection drone (20), and the third environmental inspection drone (30) sets its own inspection area by considering its own battery status, surrounding terrain status, surrounding obstacle status, or surrounding weather status, and the set inspection area of another environmental inspection drone (2).

In addition, the first environmental inspection drone (10), the second environmental inspection drone (20), and the third environmental inspection drone (30) sequentially set the inspection areas that they should inspect. First, the first environmental inspection drone (10) sets the inspection areas that it should inspect. At this time, the first environmental inspection drone (10) sets the inspection areas that it should inspect by considering the battery status, the surrounding terrain status, the surrounding obstacle status, or the surrounding weather status. The first environmental inspection drone (10) checks its own battery status to determine how long it can fly, determines the terrain status of its surroundings, determines the obstacle status of its surroundings, and determines the weather status of its surroundings to set the inspection areas that it should inspect.

The first environmental inspection drone (10) checks its battery status to determine the maximum flight time, and determines the round trip time required to safely return to the return point based on the maximum flight time to determine the time available for environmental inspection, and determines the maximum movement distance based on the time available for environmental inspection and the movement speed of the first environmental inspection drone (10), and sets the maximum movement distance as the maximum movement radius. In addition, the area of a three-dimensional virtual sphere formed by the set maximum movement radius is set as the initial environmental inspection area of the first environmental inspection drone (10).

For example, if the first environmental inspection drone (10) has 80% of its battery remaining, it calculates the battery consumption per hour and determines that the maximum flight time is 20 minutes, and half of that, 10 minutes, can be used for environmental inspection and the remaining 10 minutes can be used for return. It determines the maximum movement distance that the first environmental inspection drone (10) can move during the 10 minutes that can be used for environmental inspection by considering the movement speed of the first environmental inspection drone (10). If the movement speed of the first environmental inspection drone (10) is 100 meters/minute, the first environmental inspection drone (10) can move a maximum of 1 km during 10 minutes, and it determines that 1 km is the maximum movement distance, and sets the maximum movement distance of 1 km as the maximum movement radius. In addition, the area of a three-dimensional virtual sphere formed by the set maximum movement radius of 1 km is set as the initial environmental inspection area of the first environmental inspection drone (10).

The first environmental inspection drone (10) sets an initial environmental inspection area and then adjusts the initial environmental inspection area by considering the surrounding terrain conditions, surrounding obstacle conditions, or surrounding weather conditions.

The first environmental inspection drone (10) sets the initial environmental inspection area and then determines the surrounding terrain condition. In addition, the initial environmental inspection area is adjusted based on the determined surrounding terrain condition. For example, if the initial environmental inspection area includes a cliff area, a steep slope area, a rugged mountain area, etc., the first environmental inspection drone (10) excludes the area from the initial environmental inspection area.

In addition, the first environmental inspection drone (10) can exclude environmental inspection areas above or below a certain altitude from the initial environmental inspection area. For example, if the surrounding terrain is flat terrain such as a coastal area or a plain area, the first environmental inspection drone (10) can perform environmental inspection at a low altitude, so areas above a certain altitude are excluded from the initial environmental inspection area. If the surrounding terrain is densely wooded or has terrain such as sand dunes, the first environmental inspection drone (10) must perform environmental inspection at a high altitude, so areas below a certain altitude are excluded from the initial environmental inspection area.

The first environmental inspection drone (10) sets an initial environmental inspection area, then determines the surrounding terrain condition and adjusts the initial environmental inspection area according to the determined surrounding terrain condition, and additionally adjusts the initial environmental inspection area according to the determined surrounding obstacle condition. For example, if the first environmental inspection drone (10) discovers an obstacle such as a mountain, rock, large tree, or building, the area where the obstacle exists is excluded from the initial environmental inspection area.

The first environmental inspection drone (10) additionally adjusts the initial environmental inspection area by judging the surrounding weather conditions. For example, areas with heavy rain, areas with thunder or lightning, and areas with strong winds are excluded from the initial environmental inspection area.

Through this, the first environmental inspection drone (10) additionally adjusts the initial environmental inspection area by considering the surrounding terrain conditions, surrounding obstacle conditions, surrounding weather conditions, etc. in the initial environmental inspection area, and finally determines the first environmental inspection drone inspection area (A1) where the environmental inspection will be conducted.

When the first environmental inspection drone inspection area (A1) of the first environmental inspection drone (10) is finally confirmed, the second environmental inspection drone (20) sets the environmental inspection area that it should inspect. At this time, the second environmental inspection drone (20) sets the second environmental inspection drone inspection area (A2) to be inspected in the same manner as the first environmental inspection drone (10) set the environmental inspection area, excluding the first environmental inspection drone inspection area (A1) set by the first environmental inspection drone (10). When the second environmental inspection drone (20) sets the second environmental inspection drone inspection area (A2), the third environmental inspection drone (30) sets the third environmental inspection drone inspection area (A3) to be inspected in the same manner as the first and second drones (10, 20) set the environmental inspection areas, excluding the environmental inspection areas set by the first and second environmental inspection drones (10, 20).

Meanwhile, while the first environmental inspection drone (10) is performing an environmental inspection by moving around the preset first environmental inspection drone inspection area (A1), if the environment changes (e.g., changes in the surrounding weather conditions), the preset first environmental inspection drone inspection area (A1) can be changed accordingly. For example, if a strong wind blows or heavy rain falls and the environmental inspection area that was excluded from the preset first environmental inspection drone inspection area (A1) is blown, the environmental inspection area can be included again in the first environmental inspection drone inspection area (A1) when the wind weakens or the amount of rain decreases, thereby changing the first environmental inspection drone inspection area (A1).

As the first environmental inspection drone (10) changes the first environmental inspection drone inspection area (A1) according to changes in the environment, the second environmental inspection drone (20) and the third environmental inspection drone (30) also change the second environmental inspection drone inspection area (A2) and the third environmental inspection drone inspection area (A3).

In addition, as the second environmental inspection drone (20) changes the second environmental inspection drone inspection area (A2) according to changes in the environment, the first environmental inspection drone (10) and the third environmental inspection drone (30) can also change the first environmental inspection drone inspection area (A1) and the third environmental inspection drone inspection area (A3), and as the third environmental inspection drone (30) changes the third environmental inspection drone inspection area (A3) according to changes in the environment, the first environmental inspection drone (10) and the second environmental inspection drone (20) can also change the first environmental inspection drone inspection area (A1) and the second environmental inspection drone inspection area (A2).

In addition, the first, second, and third environmental inspection drones (10, 20, 30) do not perform environmental inspections once and then end, but perform them repeatedly at regular intervals, and the environmental inspection areas of the environmental inspections that are performed repeatedly can also be changed according to changes in the environment. The first, second, and third environmental inspection drones (10, 20, 30) change the environmental inspection areas if there is a change in the environment (e.g., a change in the surrounding weather conditions) before completing the (n)th environmental inspection and starting the (n+1)th environmental inspection.

For example, in the nth environmental inspection, the wind in a strong wind area that was excluded from the preset first environmental inspection drone inspection area (A1) may weaken, so that the area may be included in the first environmental inspection drone inspection area (A1) in the n+1st environmental inspection, and accordingly, the second environmental inspection drone inspection area (A2) and the third environmental inspection drone inspection area (A3) may be changed. In addition, an obstacle in an obstacle area that was excluded from the preset second environmental inspection drone inspection area (A2) in the nth environmental inspection may disappear, so that the area may be included in the second environmental inspection drone inspection area (A2) in the n+1st environmental inspection, and accordingly, the first environmental inspection drone inspection area (A1) and the third environmental inspection drone inspection area (A3) may be changed. In addition, in an area with many buildings that were excluded from the third environmental inspection drone inspection area (A3) set in the nth environmental inspection, the buildings disappear, and in the n+1st environmental inspection, the area can be included in the third environmental inspection drone inspection area (A3), and accordingly, the first environmental inspection drone inspection area (A1) and the second environmental inspection drone inspection area (A2) are changed.

In addition, even after all environmental inspection areas to be inspected by the first, second, and third environmental inspection drones (10, 20, 30) are set, there may be environmental inspection areas that are not set as environmental inspection areas (environmental inspection areas inaccessible to the environmental inspection drones). In this case, the central control center (1) can designate the most accessible environmental inspection drone among the first, second, or third environmental inspection drones (10, 20, 30) to inspect the corresponding environmental inspection area.

That is, the central control center (1) monitors the inspection areas to be inspected by the first, second, and third environmental inspection drones (10, 20, 30) and recognizes inspection areas that are not set as inspection areas (environmental inspection areas inaccessible to environmental inspection drones). Thereafter, the central control center (1) determines accessibility by considering the current location of the drones, battery status, surrounding terrain status, surrounding obstacle status, surrounding weather status, etc., and selects the most accessible drone among the first, second, or third environmental inspection drones (10, 20, 30) to inspect the area. Through this, all inspection areas can be inspected, and complete inspection can be performed without any areas being missed. To this end, information (location, battery status, surrounding terrain status, surrounding obstacle status, surrounding weather status, etc.) of the first, second, and third environmental inspection drones (10, 20, 30) is shared in real time with other environmental inspection drones and the central control center (1).

In addition, the central control center (1) can designate the environmental inspection drone that is closest to an inspection area (an environmental inspection area inaccessible to the environmental inspection drone) among the first, second and third environmental inspection drones (10, 20, 30) or the environmental inspection drone with the longest period of use to inspect the area.

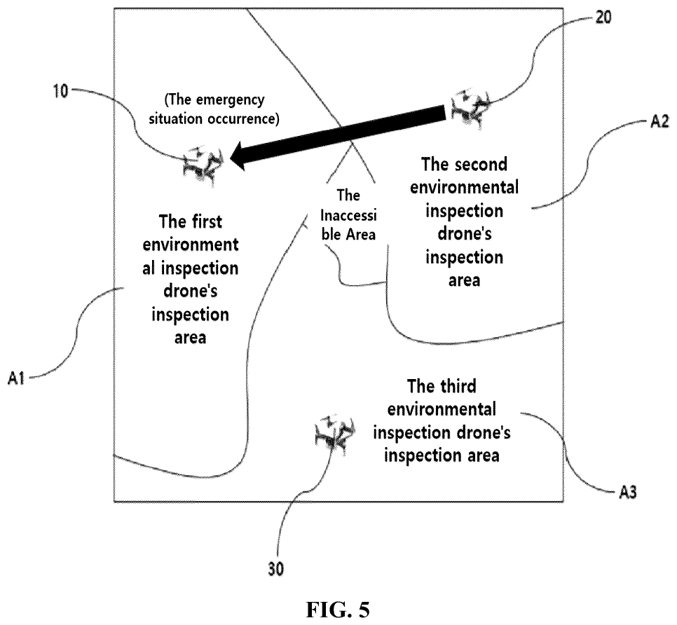

FIG. 5 is a drawing showing a plurality of environmental inspection drones cooperating with each other to inspect an environmental inspection area according to one embodiment of the present invention.

Referring to FIG. 5, the first, second and third environmental inspection drones (10, 20, 30) share the current status of each drone (battery status, failure status, etc.) with other environmental inspection drones and the central control center (1) so that the cooperative relationship among the environmental inspection drones can be adjusted in real time according to an emergency situation that occurs, thereby responding to an emergency situation.

For example, if, while the first environmental inspection drone (10) is performing an environmental inspection task, an abnormal situation occurs in the battery and it is rapidly consumed, so that the battery is insufficient to perform the remaining environmental inspection task, or if the first environmental inspection drone (10) malfunctions and the first environmental inspection drone (10) can no longer perform the environmental inspection task, the central control center (1) may designate one of the second or third environmental inspection drones (20, 30) (e.g., an environmental inspection drone located closer to the first environmental inspection drone (10)) and move it to the inspection area (A1) of the first environmental inspection drone so that it takes over the environmental inspection task that the first environmental inspection drone (10) was performing and continues to perform it.

At this time, the environmental inspection drone that has taken over the environmental inspection work of the first environmental inspection drone (10) inspects the inspection areas that have not been inspected, excluding the inspection areas where the first environmental inspection drone (10) has already completed the inspection work. This is to prevent unnecessary re-inspection of the inspection areas where the inspection has been completed. For example, if the first environmental inspection drone (10) has inspected the inspection area in the southern region, the environmental inspection drone that has taken over the environmental inspection work can inspect the inspection area in the northern region.

In addition, the first environmental inspection drone (10) can return to the initial departure point by switching the flight mode to a safe mode in the event of an emergency. In addition, the first environmental inspection drone (10) can notify the central control center (1) that an emergency has occurred, and, if necessary, the central control center (1) can remotely control the first environmental inspection drone (10) to return to the initial departure point.

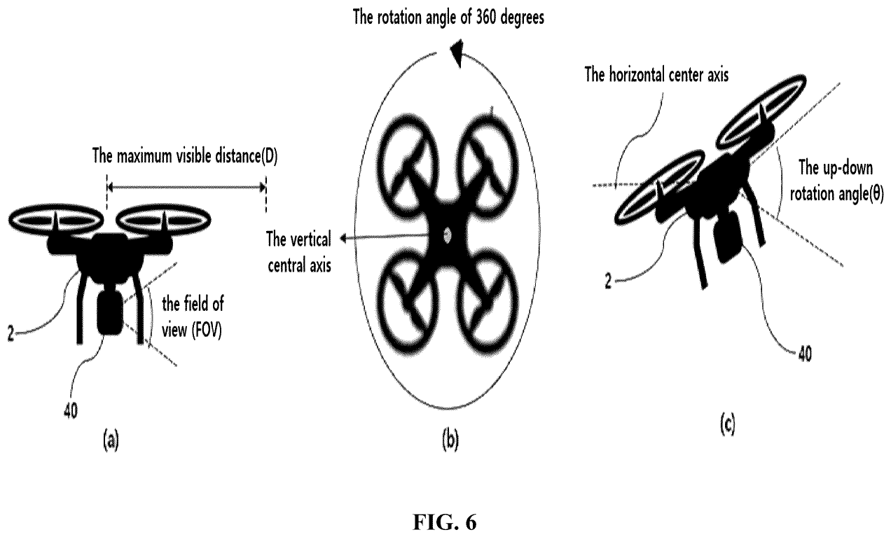

FIG. 6 is a drawing showing setting the maximum inspection area that can be inspected by an environmental inspection drone according to one embodiment of the present invention.

Referring to FIG. 6, when an environmental inspection area to be inspected by an environmental inspection drone (2) is set, the environmental inspection drone (2) sets an environmental inspection path to inspect the set environmental inspection area. At this time, before setting the environmental inspection path, the inspection area setting unit (180) first sets the maximum inspection area that can be inspected at the location where the environmental inspection drone (2) is located.

In setting the maximum inspection area that can be inspected from the location where the environmental inspection drone (2) is located, the field of view (FOV, Field of View, hereinafter referred to as “field of view”) and maximum visible distance (D) of the camera sensor (40) equipped on the environmental inspection drone (2), the rotation angle based on the vertical center axis of the environmental inspection drone (2), and the up-down rotation angle (θ) based on the horizontal center axis of the environmental inspection drone (2) are utilized.

The inspection area setting unit (180) of the environmental inspection drone (2) first sets the maximum inspection area that can be inspected at the location of the environmental inspection drone (2) by utilizing the angle of view (α) and maximum visible distance (D) of the camera sensor (40) equipped on the environmental inspection drone (2) as shown in (a) of FIG. 6, the rotation angle of 360 degrees based on the vertical center axis of the environmental inspection drone (2) as shown in (b) of FIG. 6, and the up-down rotation angle (θ) based on the horizontal center axis of the environmental inspection drone (2) as shown in (c) of FIG. 6.

The angle of view (α) of the camera sensor (40) indicates the range of the field of view that the camera sensor (40) can capture at one time. This varies depending on the lens design of the camera (40) and is measured horizontally and vertically, respectively. For example, if the angle of view of the camera sensor (40) of a specific environmental inspection drone (2) is 39.5 degrees horizontally and 27 degrees vertically, when the environmental inspection drone (2) photographs from a height of 150 m, it can photograph 108 m horizontally and 72 m vertically on the ground.

The maximum visible distance (D) of the camera sensor (40) is the maximum distance at which the camera sensor (40) can identify a specific object or point, and is determined by the focal length of the lens, sensor resolution, aperture, sensor size, noise, and signal processing capability.

The environmental inspection drone (2) can rotate 360 degrees around the vertical central axis. As the environmental inspection drone (2) rotates 360 degrees around the vertical central axis, the camera sensor (40) equipped on the environmental inspection drone (2) also rotates 360 degrees around the vertical central axis, thereby expanding the environmental area that the camera sensor (40) can inspect. The camera sensor (40) can rotate 360 degrees around the current location of the environmental inspection drone (2) and perform environmental inspection work from various angles. In addition, if the environmental inspection drone (2) completes the environmental inspection at the current location, it moves to the next inspection location, rotates 360 degrees again, and performs the environmental inspection work.

The environmental inspection drone (2) rotates up and down by the vertical rotation angle (θ) based on the horizontal center axis. As the environmental inspection drone (2) rotates up and down by the vertical rotation angle (θ), the field of view of the camera sensor (40) for environmental inspection can be expanded up and down from the field of view of the existing camera sensor (40) by the vertical rotation angle (θ) of the environmental inspection drone (2).

Through this, the environmental inspection area that can be inspected by the environmental inspection drone (2) can be expanded.

The inspection area setting unit (180) of the environmental inspection drone (2) can set the maximum inspectionable area at a specific point for environmental inspection by utilizing the angle of view (α) of the camera sensor (40) at a specific point where the environmental inspection drone (2) is located, the maximum visible distance (D) of the camera sensor (40), the 360-degree rotation angle based on the vertical center axis of the environmental inspection drone (2), and the up-down rotation angle (θ) based on the horizontal center axis of the environmental inspection drone (2).

That is, at a specific point where the environmental inspection drone (2) is located, the environmental inspection drone (2) rotates 360 degrees at a preset angle interval based on the vertical central axis, and the environmental inspection drone (2) rotates up and down as much as possible based on the horizontal central axis, and the field of view that can be secured through the camera sensor (40) up to the maximum visible distance of the camera sensor (40) can be set as the maximum inspectionable area.

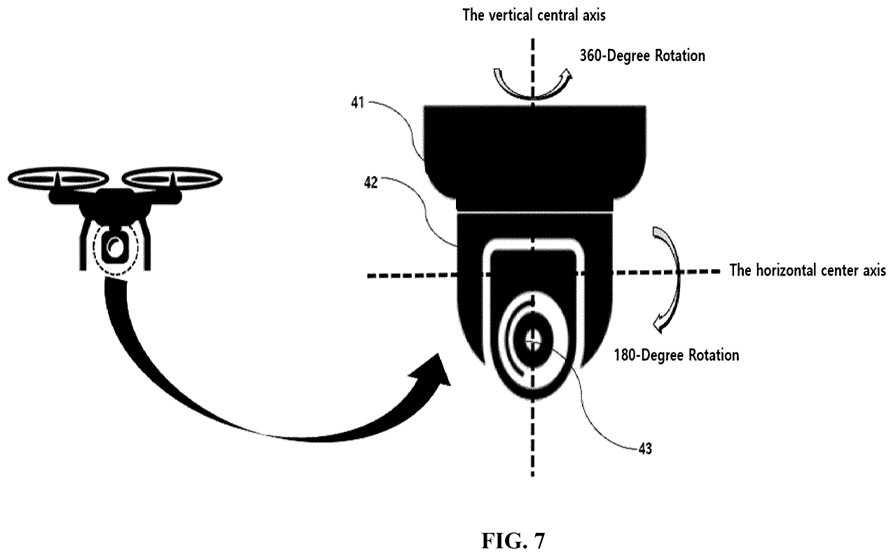

FIG. 7 is an enlarged view showing a camera sensor equipped on an environmental inspection drone according to one embodiment of the present invention.

Referring to FIG. 7, the camera sensor (40) equipped on the environmental inspection drone (2) is composed of a first support part (41), a second support part (42), and a lens part (43).

The first support member (41) is fixed to the environmental inspection drone (2) and supports the camera sensor (40), and the second support member (42) includes a lens member (43) inside and is connected to the first support member (41). In addition, the second support member (42) can rotate around the vertical central axis and rotate 360 degrees, and the lens member (43) can rotate around the horizontal central axis and rotate 180 degrees.

The second support member (42) rotating 360 degrees around the vertical central axis has the same effect as the environmental inspection drone (2) described in FIG. 6 rotating 360 degrees around the vertical central axis, so that when setting the maximum inspection area, one of the two methods can be selected to set the maximum inspection area.

In addition, the field of view of the camera sensor (40) can be further expanded by rotating 180 degrees based on the horizontal central axis of the lens unit (43). That is, in the field of view that can be secured through the camera sensor (40) described in FIG. 6, the field of view that can be secured through the camera sensor (40) is further expanded by rotating the lens unit (43) 180 degrees based on the horizontal central axis, and accordingly, the maximum inspection area that can be set by the environmental inspection drone (2) at the point where the environmental inspection drone (2) is located is further expanded.

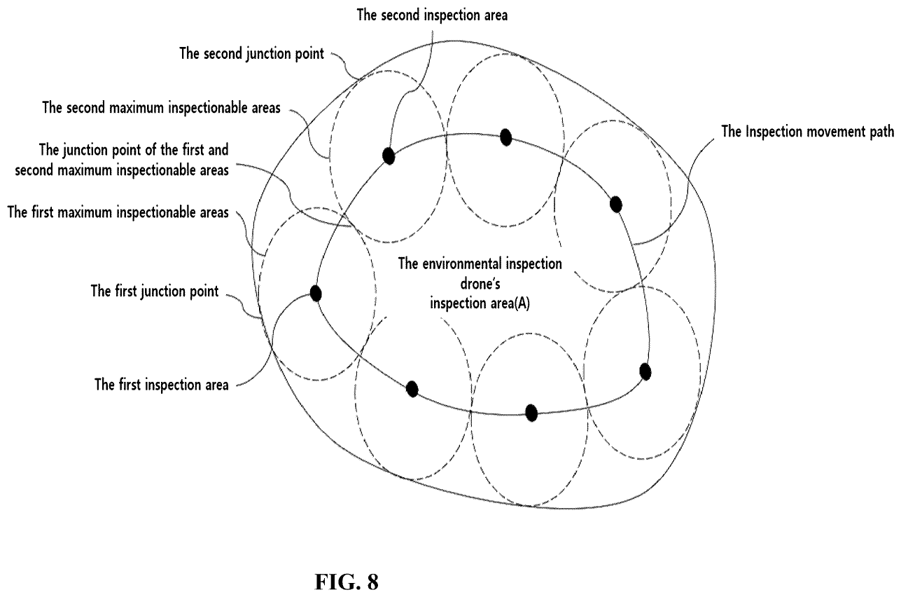

FIG. 8 is a drawing showing an environmental inspection drone according to one embodiment of the present invention setting an inspection movement path to conduct an inspection within a set environmental inspection area.

Referring to FIG. 8, when the environmental inspection drone (2) sets its own inspection area (A) by considering its own battery status, surrounding terrain status, surrounding obstacle status, or surrounding weather status, and the set inspection area of another environmental inspection drone (2) as described in FIG. 4, the environmental inspection drone (2) sets an inspection movement path to move for environmental inspection within the set inspection area (A). At this time, the environmental inspection drone (2) sets the inspection movement path by utilizing the maximum inspectionable area of the environmental inspection drone (2) described in FIG. 6 and FIG. 7.

In one embodiment of the present invention, when an inspection area (A) to be inspected by an environmental inspection drone (2) is set, an inspection movement path setting unit (190) of the environmental inspection drone (2) sets an inspection movement path for environmental inspection.

The center point of an imaginary circle (in the case of two dimensions) or sphere (in the case of three dimensions) formed by connecting the first junction point where the outermost point of the first maximum inspection area and the outermost point of the inspection area (A) are joined to each other and the junction point of the first and second maximum inspection areas where the outermost point of the first maximum inspection area and the outermost point of the second maximum inspection area are joined is set as the first inspection point.

In addition, the inspection movement path setting unit (190) sets the center point of a virtual circle (in the case of two dimensions) or sphere (in the case of three dimensions) formed by connecting the second junction point where the outermost point of the second maximum inspectionable area and the outermost point of the inspection area (A) are joined to each other and the junction point of the first and second maximum inspectionable areas where the outermost point of the first maximum inspectionable area and the outermost point of the second maximum inspectionable area are joined to the second inspection point.

Thereafter, the inspection movement path setting unit (190) sets inspection points sequentially in the same manner as the first and second inspection points are set, and connects the sequentially set inspection points to set an inspection movement path. The environmental inspection drone (2) moves along the set inspection movement path, and when it arrives at an environmental inspection point, it conducts an environmental inspection, and when it completes the environmental inspection work at the corresponding environmental inspection point, it moves to the next environmental inspection point and continues the environmental inspection.

The environmental inspection drone (2) moves along a set inspection movement path, and when the environmental inspection task is completed at all inspection points within the inspection movement path, the (n)th inspection is terminated and the (n+1)th inspection is performed.

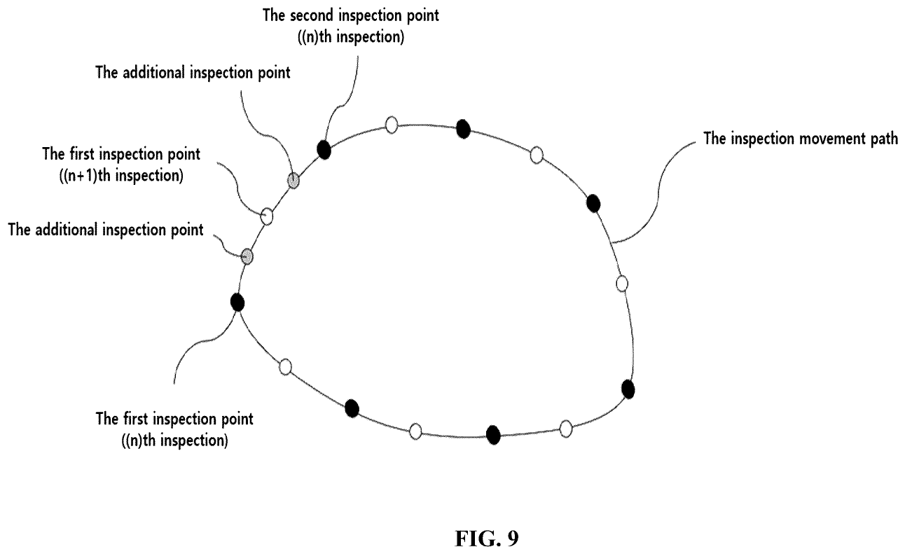

FIG. 9 is a diagram showing an inspection movement path set in (n+1)th inspection to conduct an inspection within a set environmental inspection area by an environmental inspection drone according to one embodiment of the present invention.

Referring to FIG. 9, the environmental inspection drone (2) performs an environmental inspection task while moving along the inspection movement path set by the inspection movement path setting unit (190) in the nth inspection. The environmental inspection drone (2) repeatedly performs the environmental inspection task, and after completing the (n)th inspection task, proceeds with the (n+1)th inspection task.

After completing the nth inspection and before performing the n+1th inspection task, the movement path setting unit (190) can reset the inspection points. Through this, the areas that are excluded and not inspected within the inspection area (A) can be minimized. The movement path setting unit (190) can set the midpoint between adjacent inspection points where the environmental inspection was performed in the nth inspection in the n+1th inspection task as a new inspection point.

For example, in the (n)th inspection, the midpoint between the first inspection point and the second inspection point set as the inspection point can be set as the new first inspection point in the (n+1)th inspection. The movement path setting unit (190) sets the midpoint between adjacent inspection points as the new inspection point in the same manner as described above, thereby finally confirming all (n+1)th inspection points. The environmental inspection drone (2) sequentially moves to the newly set inspection points of the inspection movement path and performs the (n+1)th inspection task.

In addition, after the n+1th inspection task is completed, the (n+2)nd inspection task can be performed while moving the inspection point where the inspection task was performed in the (n)th inspection task in the same manner, and the (n+3)rd inspection task can be performed while moving the inspection point where the inspection task was performed in the (n+1)th inspection task in the same manner. In the subsequent inspection tasks, the inspection tasks can be repeatedly performed while alternating the inspection point of the nth inspection task and the inspection point of the (n+1)th inspection task in the same manner as above.

Meanwhile, the movement path setting unit (190) can additionally set inspection points according to changes in the surrounding conditions of the environmental inspection drone (2).

For example, if the air pollution around the environmental inspection drone (2) becomes severe (as determined by the control unit (150) based on the data measured by the sensor unit (145), the movement path setting unit (190) can additionally set inspection points. At this time, the movement path setting unit (190) can set a newly added inspection point at the midpoint between the inspection point of the adjacent nth inspection and the inspection point of the n+1th inspection. In addition, additional inspection points can be set at the midpoint between the inspection point of the nth inspection adjacent to the added inspection point, and the midpoint between the inspection point of the n+1th inspection adjacent to the added inspection point. Through this, when the environmental inspection drone (2) needs to perform environmental inspection work more precisely (e.g., when the surrounding air pollution becomes severe), the environmental inspection work can be performed more precisely.

In addition, the inspection movement path and inspection points for environmental inspection set in the movement path setting unit (190) are all stored in the inspection movement path storage unit (200) and are reused when the environmental inspection drone (2) sets the inspection movement path for environmental inspection.

In addition, the environmental inspection drone (2) shares all of the work status of the environmental inspection drone (2) moving along the set inspection movement path and inspecting the environment with the central control center (1) in real time. Through this, the central control center (1) can identify all of the inspection movement path, inspection points, inspection completed areas, and inspection incomplete areas of the environmental inspection drone (2), and if there is an area that remains as an incomplete area even after the environmental inspection drone (2) has performed a preset number of repetitive tasks for repetitive environmental inspections, the central control center (1) can move the environmental inspection drone (2) to that area to perform the environmental inspection task. Through this, the environmental inspection drone (2) can be made to perform environmental inspections without omission in all areas of the set inspection area.

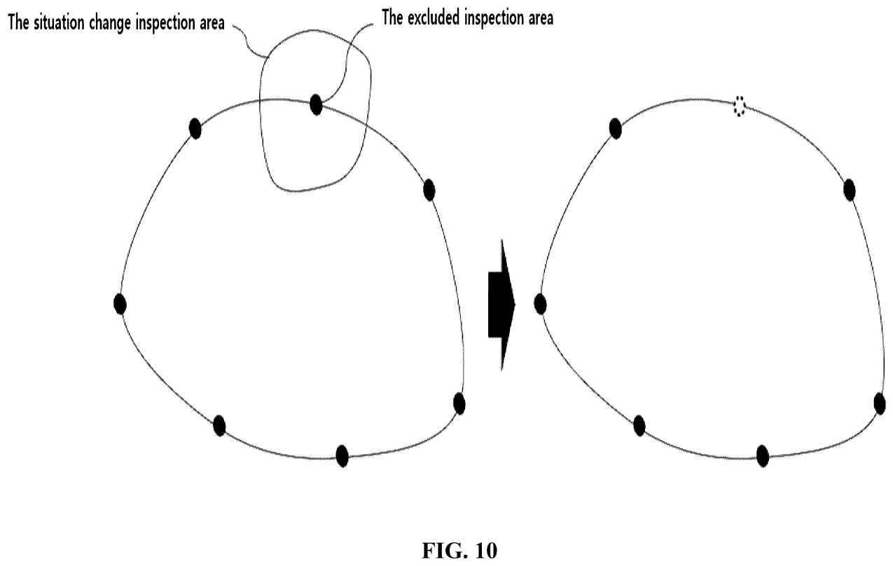

FIG. 10 is a drawing showing an environmental inspection drone according to one embodiment of the present invention and changing an inspection point according to changes in its surroundings.

Referring to FIG. 10, while the environmental inspection drone (2) is conducting an environmental inspection along a movement path, depending on changes in the environmental inspection drone (2) and its surroundings, the drone may move directly to the next inspection point without conducting an environmental inspection at a specific inspection point.

For example, when an environmental inspection drone (2) is moving along an inspection path for environmental inspection, if it determines that the battery is not sufficient for environmental inspection in a situation change inspection area, it moves directly to the next inspection point without performing an environmental inspection at the inspection point included in the situation change inspection area.

In addition, if the environmental inspection drone (2) encounters a situation of rapid weather change such as turbulence or rain showers while moving along the inspection movement path for environmental inspection in the situation change inspection area, it determines that environmental inspection is impossible and does not perform environmental inspection at the inspection point included in the situation change inspection area and moves directly to the next inspection point.

For example, the environmental inspection drone (2) continuously monitors the battery status during the mission, and when the battery level falls below a threshold, the inspection movement path setting unit (190) modifies the current path of the environmental inspection drone (2) to move to the nearest charging point. For example, when the battery level of the environmental inspection drone (2) falls below 20% during the flight, the inspection movement path setting unit (180) calculates the shortest path to the charging station and starts the movement of the environmental inspection drone (2), and when charging is completed, it returns to the previous inspection location and resumes the mission.

In addition, the environmental inspection drone (2) scans and analyzes the surrounding terrain in real time using sensors such as radar, LiDAR, and cameras, and when an obstacle is discovered, the inspection movement path setting unit (190) modifies the path to avoid it. For example, when the environmental inspection drone (2) discovers a tall tree while flying over mountainous terrain, the inspection movement path setting unit (190) recognizes this and adjusts the altitude to modify the path to avoid the tree.

In addition, the environmental inspection drone (2) monitors weather changes in real time during the flight based on weather detection sensors and weather data. For example, if a strong wind is detected during the flight, the inspection movement path setting unit (190) of the environmental inspection drone (2) analyzes the wind strength and direction to re-set a safe flight path, and if necessary, lands in a safe location or adjusts the flight altitude.

In addition, when multiple environmental inspection drones (2) perform work simultaneously, each environmental inspection drone (2) shares its location and path with each other in real time. This adjusts the path to avoid collision and increase inspection efficiency. For example, when multiple environmental inspection drones (2) inspect the edge area of the inspection area they are inspecting, each environmental inspection drone (2) checks the location of other environmental inspection drones (2) and the distance between environmental inspection drones (2) to avoid collision and proceed with the inspection.

Meanwhile, the environmental inspection drone (2) moves along the inspection movement path set by the inspection movement path setting unit (190) to inspect the environment, and collects environmental data using a high-resolution camera sensor, LIDAR sensor, ultrasonic sensor, etc. equipped with the sensor unit (145). For example, the environmental inspection drone (2) flies over a forest and collects the location and height of trees, terrain ups and downs, obstacle locations, and dangerous areas. In addition, the data collected by the environmental inspection drone (2) is transmitted to the central control center (1).

The central control center (1) receives the data collected by the environmental inspection drone (2) and analyzes it to create a 3D map. As the number of inspections by the environmental inspection drone (2) increases, the data transmitted by the environmental inspection drone (2) to the central control center (1) increases, and accordingly, the 3D map created by the central control center (1) is continuously updated and becomes more sophisticated.

The inspection movement path setting unit (190) of the environmental inspection drone (2) sets the inspection movement path based on the updated 3D map. When the inspection movement path setting unit (190) sets the movement path, an artificial intelligence-based inspection movement path setting algorithm can be utilized. The artificial intelligence-based inspection movement path setting algorithm calculates the optimal movement path based on the previous movement path of the environmental inspection drone (2) and the updated 3D map. The AI-based inspection movement path setting algorithm resets the path in real time when it detects a change in the new environment or an obstacle. For example, if the environmental inspection drone (2) discovers that a tree has grown on the previously moved path, it searches for and sets a new path to avoid it.

If the environmental inspection drone (2) detects a new obstacle while moving, it corrects its path in real time. The environmental inspection drone (2) utilizes a high-resolution camera sensor, a LIDAR sensor, an ultrasonic sensor, etc., equipped with a sensor unit (145) to correct its path in real time. The sensor unit (145) includes a high-resolution camera sensor, a LIDAR sensor, an ultrasonic sensor, etc., to scan the moving environment in which the environmental inspection drone (2) moves, and if it detects a new obstacle while moving, the inspection movement path setting unit (180) immediately calculates a new path that can be safely flown using an artificial intelligence-based inspection movement path setting algorithm and applies it to correct the movement path of the environmental inspection drone (2).

For example, the environmental inspection drone (2) determines whether it can reach the first destination along the first movement path by considering the current movement conditions (remaining battery level, weather conditions, obstacles, etc.). For example, if the battery is insufficient or an obstacle occurs on the path, it determines that it cannot reach. If the environmental inspection drone (2) cannot reach the first destination, the environmental inspection drone (2) searches for a second movement path and evaluates whether it can reach the first destination through the second movement path. If it can reach the first destination using the second movement path, the environmental inspection drone (2) sets that path as an emergency movement path. In addition, even if it can reach the first destination using a part of the second movement path, the environmental inspection drone (2) sets an emergency movement path along that path.

In addition, the environmental inspection drone (2) determines whether it can reach the first destination along the first movement path by considering the current movement conditions (remaining battery level, weather conditions, obstacles, etc.). For example, if an obstacle occurs on the first movement path, the environmental inspection drone (2) determines that it cannot reach the first destination. If the environmental inspection drone (2) cannot reach the first destination due to the obstacle, the environmental inspection drone (2) searches for a second movement path that avoids the obstacle and deviates the least from the first movement path, and sets that path as an emergency movement path. In addition, the environmental inspection drone (2) moves along the second movement path to avoid the obstacle, and if it avoids the obstacle, it returns to the first movement path and moves along the first movement path to the first destination.

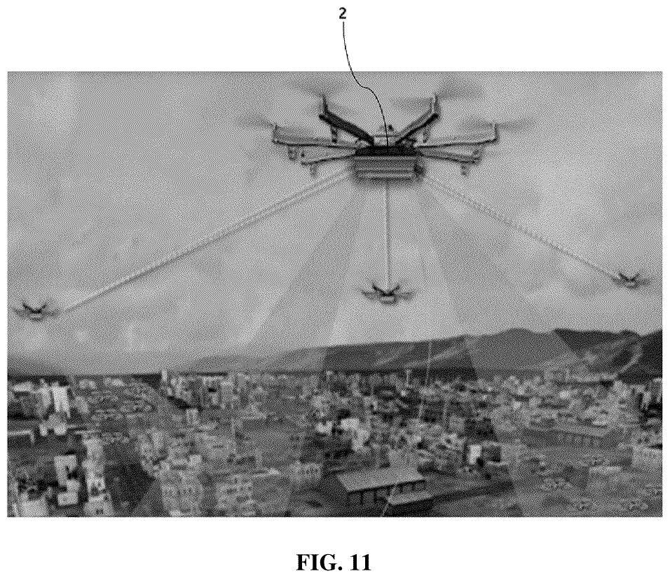

FIG. 11 is a drawing showing an atmospheric environment inspection unit of an environmental inspection drone inspecting the atmospheric environment according to one embodiment of the present invention.

Referring to FIG. 11, the sensor unit (145) of the environmental inspection drone (2) is equipped with an atmospheric sensor that measures the air quality of the atmospheric environment. In addition, the atmospheric environment inspection unit (210) analyzes the air quality of the atmospheric environment based on the data measured by the atmospheric sensor. The atmospheric sensor may be equipped with a laser scattering sensor, and the laser scattering sensor is used to measure the concentration of particles in the air. A laser is shot into the air and the degree to which particles scatter the laser is measured to determine the concentration of fine dust (PM2.5, PM10). In addition, the atmospheric sensor may be equipped with an electrochemical sensor, and the electrochemical sensor measures the concentration of a specific gas. A cell containing electrodes and electrolytes reacts with a gas to generate an electric signal, and through this, the concentration of nitrogen dioxide (NO2), carbon monoxide (CO), ozone (O3), etc. can be measured. In addition, the atmospheric sensor may be equipped with a thermal conductivity sensor, and the thermal conductivity sensor measures the thermal conductivity of a specific gas in the air. Since the thermal conductivity varies depending on the concentration of the gas, the concentration of hydrogen (H2), methane (CH4), etc. can be detected through this. In addition, the atmospheric sensor may be equipped with an optical sensor, and the optical sensor measures pollutants in the air using the absorption, reflection, or transmission characteristics of light. Using light of various wavelengths such as ultraviolet and infrared, the concentration of sulfur dioxide (SO2), ammonia (NH3), etc. can be detected. In addition, the atmospheric sensor can be equipped with a satellite-based sensor, and the satellite-based sensor can detect pollutants in the atmosphere over a wide area. Equipment such as the Ozone Monitoring Instrument (OMI) can measure ozone, nitrogen dioxide, etc. in the atmosphere.

The air quality inspection unit (210) determines that there is an abnormality in air quality if the air data value measured by the air sensor exceeds the preset standard value.

In addition, the environmental inspection drone (2) can adjust the interval between inspection points according to the air pollution level. If the air pollution level is severe (if the air pollution level is higher than the preset reference value), the interval between inspection points can be set narrowly by setting additional inspection points as described in FIG. 9, so that inspection work can be performed more frequently and the accuracy of the inspection can be improved. If the air pollution level is not severe (if the air pollution level is lower than the preset reference value), the interval between inspection points can be set wide by moving directly to the next inspection point without inspecting the inspection point as described in FIG. 10, so that the inspection time can be reduced and the battery can be saved.

To this end, before setting up inspection points, the level of air pollution can be identified through a preliminary inspection, and through this, the air pollution level can be determined in advance and the interval between inspection points for inspecting the atmosphere can be set. In addition, information on the air pollution level of the inspection area can be provided from the central control center (1) before the inspection, and the interval between inspection points for inspecting the atmosphere can be set.

In cases where air pollution is severe (air pollution levels exceed the preset standard value), the intervals between inspection points are set narrowly to measure air pollution levels more precisely. For example, in industrial complexes or urban areas with heavy traffic, the intervals between inspection points are set narrowly to 50 meters. The narrow intervals between inspection points enable more frequent measurements of air pollution levels in each subarea, allowing air pollution levels to be identified in each subarea, and air pollutants to be identified in each subarea.

In addition, by identifying and comparing the air pollution level and air pollutants by detailed area, it is possible to identify the location of the air pollution source that causes air pollution. For example, if the air pollution level of the detailed area located in the eastern region is higher than that of the detailed area located in the western region when there is not much wind and the air pollutants of the two regions are similar, it can be inferred that the air pollution source that causes air pollution is causing air pollution in a location further east than the detailed area located in the eastern region. In addition, if the air pollutants of the detailed areas located in the western region and the detailed areas located in the eastern region are similar and the air pollution level of the detailed area located in the western region is higher than that of the detailed area located in the eastern region when the wind blows from west to east, it can be inferred that the air pollution source is causing air pollution in a location further west than the detailed area located in the western region.

In addition, even after setting inspection points at regular intervals, the interval between inspection points can be adjusted depending on the situation within the inspection area. For example, in a sub-area within the inspection area where buildings or factories are gathered and generate a lot of air pollutants, the interval between inspection points can be set narrowly, and in a sub-area within the inspection area where pollutants are not generated much, the interval between inspection points can be set wide.

Through this, in areas where the interval between inspection points is set close, more time and battery are consumed for air pollution level inspection, and in areas where the interval between inspection points is set wide, less time and battery are consumed for air pollution level inspection, so that the time required for inspection and battery use can be selectively controlled. In addition, the interval between inspection points can be adjusted while the environmental inspection drone (2) is conducting an environmental inspection. When the environmental inspection drone (2) arrives at a specific inspection point for inspection, a preliminary inspection can be conducted at the specific inspection point, through which the level of air pollution can be identified before the inspection. The level of air pollution at the inspection point can be identified in advance through a preliminary inspection (a simpler inspection than the main inspection, for example, only a few important air pollution items in the air pollution items of the main inspection) before the inspection (or, the level of air pollution at the inspection point is shared in advance from the central control center (1)), and if the level of air pollution is lower than the preset reference value, the environmental inspection drone (2) can move directly to the next inspection point without conducting an inspection at the inspection point. This has the same effect as widening the interval between inspection points because the air pollution level is low.

In addition, if the environmental inspection drone (2) arrives at a specific inspection point for inspection and conducts a preliminary inspection at the arrival inspection point, and the preliminary inspection results show that the level of air pollution at the specific inspection point is higher than a preset reference value, then after completing the inspection at the inspection point, instead of moving to the next preset inspection point, a third inspection point between the inspection point and the next preset inspection point is set, and the drone moves to the third inspection point to conduct an additional inspection. This has a similar effect to narrowing the gap between inspection points when the air pollution level is high.

Meanwhile, the environmental inspection drone (2) moves to all inspection points and can set the inspection time interval until the next two inspection times after completing one inspection, and can also set the inspection time required at a specific inspection point upon arrival at the specific inspection point.

The environmental inspection drone (2) can set the inspection time interval to be constant from the completion of one inspection to the second inspection. In addition, the inspection time interval can be increased or decreased depending on the air pollution situation. That is, if the air pollution level is severe (if the air pollution level is higher than the preset standard value), the inspection time interval can be decreased, and if the air pollution level is not severe (if the air pollution level is lower than the preset standard value), the inspection time interval can be increased.

For example, an environmental inspection drone (2) moves sequentially to the set inspection points and measures air pollution levels. Assuming that it takes 3 hours to move to 5 inspection points and complete one inspection, one inspection can be conducted from 9:00 AM to 12:00 PM today. In addition, after one inspection is completed, the interval between the second and third inspection times can be set, and the second inspection can be set to be conducted from 9:00 AM to 12:00 PM the next day at the same time, and the third inspection can be set to be conducted from 9:00 AM to 12:00 PM the next day at the same time. In this way, the inspection time interval can be set to be a constant 24 hours.

In addition, the inspection time interval can be adjusted according to the air pollution level. For example, in urban areas such as areas with severe air pollution (areas where the air pollution level is higher than the preset standard value), the inspection time interval can be set as short as 12 hours, and in rural areas such as areas with light air pollution (areas where the air pollution level is lower than the preset standard value), the inspection time interval can be set as long as 36 hours.

Meanwhile, the inspection time at a specific inspection point can be adjusted depending on the degree of air pollution at that inspection point. If the preliminary inspection results show that the air pollution at a specific inspection point is severe (if the air pollution level is higher than the preset standard value), the inspection time at that inspection point can be increased, and if the air pollution level is not severe (if the air pollution level is lower than the preset standard value), the inspection time at that inspection point can be reduced.

Meanwhile, inspection points can also be set according to weather conditions.

Meteorological conditions affect air pollution levels, and air pollution levels change depending on changes in factors that change meteorological conditions (e.g., temperature, wind, precipitation, atmospheric pressure, etc.). That is, high temperatures (when the temperature value is above the preset reference value) provide favorable conditions for ozone (O3) production, which can increase ozone concentration and increase air pollution levels, and low temperatures (when the temperature value is below the preset reference value) provide unfavorable conditions for ozone (O3) production, which can decrease ozone concentration and reduce air pollution levels.

In addition, wind direction and wind speed affect air pollution levels as follows. The direction and speed of the wind can affect the direction and speed of movement of air pollutants. If the wind speed is fast (the speed value is above the preset reference value), pollutants can be quickly dispersed, which can quickly reduce air pollution levels. If the wind speed is slow (the speed value is below the preset reference value), pollutants can be slowly dispersed, which can slowly reduce air pollution levels.

Rain washes away pollutants remaining in the air in polluted areas. If there is a lot of precipitation (if the precipitation amount is above the preset standard value), the pollutants remaining in the air can be washed away quickly, so the air pollution level can be reduced quickly. If there is a little precipitation (if the precipitation amount is below the preset standard value), the pollutants remaining in the air can be washed away slowly, so the air pollution level can be reduced slowly.

The state of atmospheric pressure can also affect air pollution levels. In high-pressure conditions (when the pressure value is above the preset standard value), the stability of the atmosphere is high and the movement of the atmosphere is not active. Accordingly, pollutants tend to stagnate, so air pollution levels can be reduced slowly. In low-pressure conditions (when the pressure value is below the preset standard value), the stability of the atmosphere is low and the movement of the atmosphere is active. Accordingly, pollutants tend to move easily, so air pollution levels can be reduced quickly.

Information on the status of elements that change weather conditions can be confirmed by the environmental inspection drone (2) through preliminary inspection and can also be transmitted through the central control center (1). The environmental inspection drone (2) can utilize this to set inspection points according to the status of elements that change weather conditions.

In inspection areas where the temperature is high, the wind speed is slow, the precipitation is low, or the atmospheric pressure is high, the spacing between inspection points can be set narrowly, and in inspection areas where this is the opposite case, the spacing between inspection points can be set wide.

In addition, in inspection areas where the temperature is high, the wind speed is slow, the precipitation is low, or the atmospheric pressure is high, the time interval between the number of inspections after one inspection is completed and the next inspection time is set short, and in inspection areas where this is the opposite case, the time interval between the number of inspections after one inspection is completed and the next inspection time is set long.

Additionally, in inspection areas where the temperature is high, the wind speed is slow, the precipitation is low, or the atmospheric pressure is high, the inspection time at a specific inspection point can be increased, and in inspection areas where this is not the case, the inspection time at a specific inspection point can be reduced.

Meanwhile, the environmental inspection drone (2) can change the inspection point as the factors that change the weather conditions change during the inspection process. For example, when the environmental inspection drone (2) arrives at the inspection point for inspection, it can conduct a preliminary inspection at the arrival inspection point, and it can identify information on the change in the status of the factors that change the weather conditions of the inspection point before the inspection (or, it can receive information on the change in the status of the major weather factors of the inspection point from the central control center (1)). If the change in the status of the factors that change the weather conditions of the inspection point is identified in advance through the preliminary inspection before the inspection and the status of the factors that change the weather conditions is lower than the preset reference value, the wind speed is fast, the precipitation is high, or the air pressure is low, the environmental inspection drone (2) can move to the next inspection point without conducting the inspection at the relevant inspection point. This has the same effect as widening the interval between inspection points.

In addition, after the environmental inspection drone (2) arrives at the inspection point for inspection and conducts a preliminary inspection at the arrival inspection point, if the preliminary inspection results indicate that the conditions of factors affecting the weather at the inspection point deviate from the preset reference values, specifically if the temperature is higher, the wind speed is slower, the precipitation is lower, or the atmospheric pressure is in a high-pressure state, after completing the inspection at the inspection point, instead of moving to the next preset inspection point, a third inspection point between the inspection point and the next preset inspection point is set, and the inspection can be performed by moving to the third inspection point. This has the same effect as narrowing the gap between the inspection points.

In addition, depending on the wind speed and precipitation, the environmental inspection drone (2) can adjust its altitude when inspecting air pollution at an inspection point. When arriving at a specific inspection point according to the direction of movement of the environmental inspection drone (2), if the wind speed at the arrival inspection point is too fast or there is a lot of precipitation, the environmental inspection drone (2) can perform the inspection at a lower altitude than the normal altitude in order to perform the inspection safely.

If the wind speed and precipitation at the inspection point are at normal values, the environmental inspection drone (2) performs the inspection at a normal altitude. To this end, altitude information for performing the inspection by the environmental inspection drone (2) according to the wind speed and precipitation values may be preset and stored in the storage unit (140). During the inspection, the environmental inspection drone (2) adjusts its altitude by referring to the altitude information for performing the inspection, which is preset and stored in the storage unit (140), according to the wind speed and precipitation values.

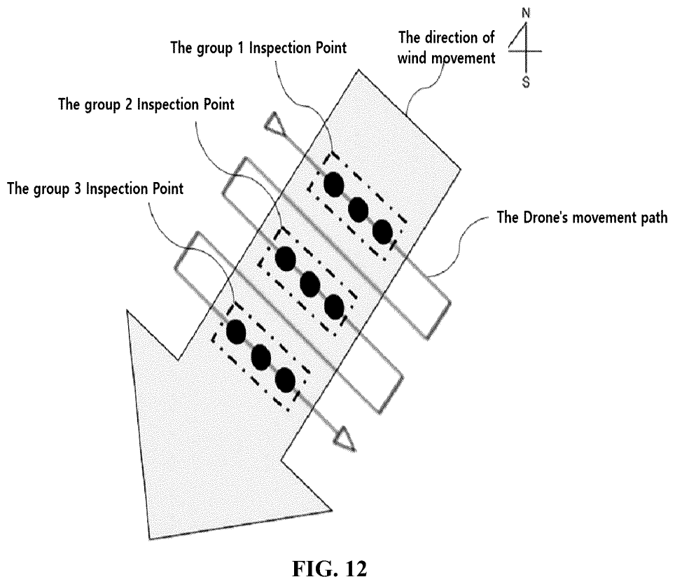

FIG. 12 is a drawing showing setting an inspection point according to the direction of wind movement in an atmospheric environment inspection unit of an environmental inspection drone according to one embodiment of the present invention.

Referring to FIG. 12, the atmospheric environment inspection unit (210) can set the inspection point of the environmental inspection drone (2) according to the direction of wind movement.

For example, the air environment inspection unit (210) can set up multiple inspection points formed sequentially by group at regular intervals according to the windward direction (the direction from which the wind blows, northeast) and the downwind direction (the direction to which the wind blows, southwest).

The air environment inspection unit (210) can set a first group inspection point, a second group inspection point, and a third group inspection point, and each group inspection point includes a plurality of inspection points. The environmental inspection drone (2) moves to a plurality of inspection points of the first group inspection point and conducts an environmental inspection, then moves to a plurality of inspection points of the second group inspection point and conducts an environmental inspection, and then moves to a plurality of inspection points of the third group inspection point and conducts an environmental inspection.

Each group inspection point can be set according to the wind speed. If the wind speed is higher than the preset value, the wind speed is judged to be fast, so the second group inspection point can be set without setting, and the distance between each group inspection point can be set wide (only the first group inspection point and the third group inspection point can be set), and if the wind speed is lower than the preset value, the wind speed is judged to be slow, so the second group inspection point can be set, and the distance between each group inspection point can be set narrow.

The number or interval of multiple inspection points included in each group inspection point can also be set differently depending on the wind speed. If the wind speed is higher than the preset value, the wind speed is judged to be fast (it is judged that pollutants are moving fast), so the number of multiple inspection points can be reduced or the interval can be set wider (so that air polluted areas can be inspected more leisurely), and if the wind speed is lower than the preset value, the wind speed is judged to be slow (it is judged that pollutants are moving slowly), so the number of multiple inspection points can be increased or the interval can be set narrower (so that air polluted areas can be inspected more precisely).

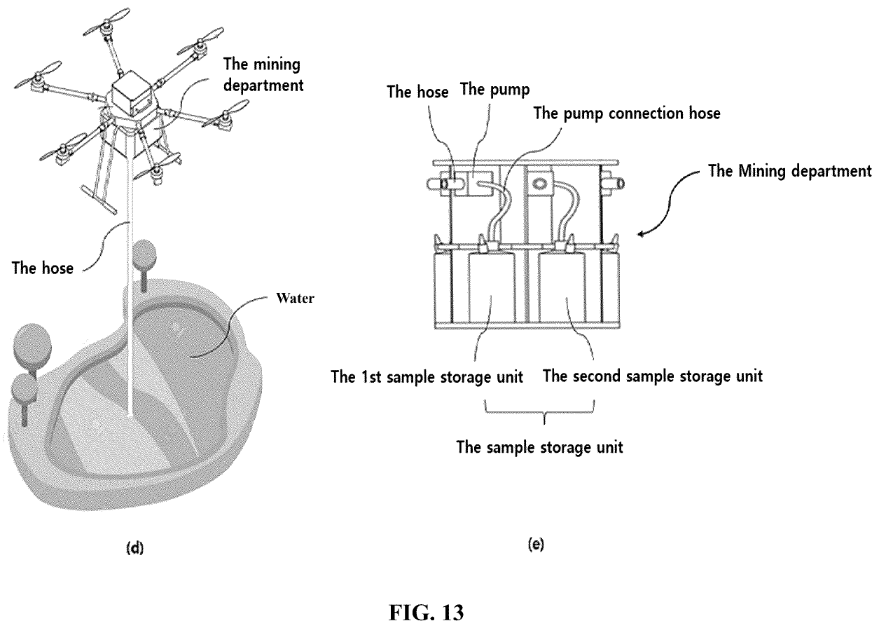

FIG. 13 is a drawing showing a water quality environment inspection unit of an environmental inspection drone inspecting a water quality environment according to one embodiment of the present invention.

Referring to FIG. 13, the sensor unit (145) of the environmental inspection drone (2) is equipped with a water quality measurement sensor that measures water quality. In addition, the water quality environmental inspection unit (220) analyzes the water quality based on the data measured by the water quality measurement sensor.

The water quality measurement sensor may be equipped with a turbidity sensor, and the turbidity sensor measures the turbidity of water to determine the concentration of suspended solids. Turbidity is an important indicator for determining water pollution. In addition, the water quality measurement sensor may be equipped with a pH sensor, and the pH sensor measures the acidity or alkalinity of water. The pH value indicates the chemical state of water and is one of the important characteristics of water quality. In addition, the water quality measurement sensor may be equipped with a residual chlorine sensor, and the residual chlorine sensor measures the concentration of residual chlorine in water to provide information related to the disinfection effect. The concentration of residual chlorine in water is particularly important for evaluating the safety of tap water. In addition, the water quality measurement sensor may be equipped with an Electrical Conductivity Sensor, which measures the electrical conductivity of water to determine the ion concentration. The electrical conductivity of water is used to evaluate the purity and contamination of water. In addition, the water quality measurement sensor may be equipped with a Temperature Sensor, which measures the temperature of water to monitor changes in water quality. Temperature is an important factor affecting other water quality parameters. In addition, the water quality measurement sensor may be equipped with a Dissolved Oxygen Sensor, which measures the concentration of oxygen dissolved in water. The concentration of oxygen dissolved in water is an important indicator for evaluating the health of an aquatic ecosystem. In addition, the water quality measurement sensor may be equipped with a multi-parameter sensor. A multi-parameter sensor is a sensor that can measure multiple water quality parameters simultaneously, thereby increasing the efficiency of water quality monitoring.

The environmental inspection drone (2) can utilize the camera sensor (40) equipped in the sensor unit (145) for water quality inspection. At this time, the camera sensor (40) utilized may be a hyperspectral camera sensor (40). The hyperspectral camera sensor (40) is a device that captures images by utilizing multiple wavelength bands of the electromagnetic spectrum, and can analyze light of various wavelengths in detail, thereby identifying various chemical components and pollutants contained in water.

The environmental inspection drone (2) moves through the water quality inspection area and takes pictures of the water surface in the water quality inspection area using the hyperspectral camera sensor (40) equipped in the sensor unit (145). The hyperspectral image taken by the hyperspectral camera sensor (40) contains information of various wavelength bands, so the water quality environmental inspection unit (220) analyzes this to determine the chemical composition and pollution status in the water. At this time, the water quality environmental inspection unit (220) can use an image processing algorithm to analyze the hyperspectral image.

For example, the water quality environment inspection department (220) extracts various parameters related to water quality by utilizing the image processing algorithm MPP (Multispectral Photometry and Polarimetry, hereinafter referred to as ‘MPP’) algorithm. Through this, water color, turbidity, chlorophyll concentration, dissolved organic matter, etc. can be accurately measured.

The MPP algorithm is a method to analyze data patterns more accurately by modifying a polynomial model. It is very useful for handling nonlinearity of data and provides high accuracy even in complex environments such as water quality data. The MPP algorithm collects water quality data including reflectance information for light of various wavelengths from a hyperspectral camera sensor (40). The collected data undergoes preprocessing processes such as noise removal and normalization, and is converted into a form suitable for analysis, and the MPP algorithm is applied to the preprocessed data. The MPP algorithm analyzes the preprocessed data through the following processes. The MPP algorithm sets up an appropriate polynomial model to predict water quality parameters, learns the parameters of the model based on the collected data, and predicts and analyzes the water quality parameters using the learned model.

Meanwhile, the main water quality parameters that can be extracted through the MPP algorithm can be as follows: chromaticity, which analyzes the color change of water to determine the presence of pollutants; turbidity, which measures the clarity of water to determine the concentration of suspended solids; chlorophyll concentration, which measures the amount of phytoplankton in water to evaluate the nutritional status; and dissolved organic matter (DOM), which analyzes the amount of organic matter dissolved in water to determine the degree of pollution.

Water quality analysis using the MPP algorithm can be utilized in various water bodies such as coastlines, rivers, and lakes. For example, in coastal water quality monitoring, data captured by a hyperspectral camera sensor (40) can be analyzed using the MPP algorithm to monitor the chlorophyll concentration and turbidity of seawater in real time.

In another embodiment, water quality analysis using the MPP algorithm can analyze water quality by combining multispectral data and polarization data to precisely analyze various properties of water.

The MPP algorithm utilizes multispectral data of objects reflecting or transmitting light. The water quality environment inspection unit (220) collects data by measuring light reflected from the surface of water at multiple wavelengths (e.g., visible light, near-infrared light, ultraviolet light, etc.) using a multispectral sensor or hyperspectral camera sensor (40) equipped in the sensor unit (145). For example, the multispectral sensor or hyperspectral camera sensor (40) equipped in the sensor unit (145) flies over the surface of a lake and measures the reflectance of light at multiple wavelengths.

The water quality environment inspection unit (220) collects polarization data by measuring the reflectance of light polarized in a specific direction on the water surface using a polarization sensor equipped in the sensor unit (145), and analyzes the collected polarization data to determine the light scattering pattern on the water surface.

The water quality environment inspection unit (220) utilizes a polarization sensor equipped in the sensor unit (145). The polarization sensor detects the polarization state of light. When light is reflected on the surface of water, a polarization phenomenon occurs, and the state of the water is analyzed using this polarization information. The polarization sensor measures the polarization information of light reflected from the surface of water, and through this, determines the reflectivity of light polarized in a specific direction. The reflectivity is an important indicator of how much light is reflected from the surface of water, and the direction and amount of reflected light vary depending on the surface state of the water or the type of material.

For example, clean water and polluted water have differences in the way they reflect or scatter light. The water quality environment inspection unit (220) collects and analyzes this polarization data to identify the light scattering pattern on the water surface. The analysis provides important information for evaluating the state of the water, and the light scattering pattern can provide a clue to identify the type and concentration of particles or substances existing on the water surface. The water quality environment inspection unit (220) analyzes the collected polarization data to determine the state of the water based on the light reflection and scattering pattern on the water surface.

The collected data undergoes a preprocessing process. The collected multispectral and polarization data may contain noise or external interference, so the preprocessing process removes such noise, corrects the geographical location to map the exact location where the environmental inspection drone (2) collected data using GPS data, and corrects the data by considering the detailed specifications of the multispectral sensor or hyperspectral camera sensor (40) and the influence of the environment (e.g., weather, atmospheric conditions) to more accurately extract the reflection characteristics of the actual water.

The preprocessed data is then precisely analyzed. To analyze the color, turbidity, chlorophyll concentration, and dissolved organic matter (DOM) of the water, each substance's unique reflection or absorption pattern at a specific wavelength is analyzed.

The chromaticity of water is analyzed based on the reflectance measured at specific wavelengths in the visible light spectrum. For example, the chromaticity of water is analyzed by comparing and analyzing the reflectance of blue and green wavelengths. Turbidity is the degree to which light is scattered or absorbed by suspended matter in water, and turbidity is analyzed by analyzing the attenuation pattern of light at multiple wavelengths. Chlorophyll concentration exhibits strong absorption characteristics at specific near infrared (NIR) and red wavelengths, so chlorophyll concentration is analyzed by analyzing the decrease in reflectance at these wavelengths. Dissolved organic matter (DOM) exhibits strong absorption characteristics at ultraviolet and blue wavelengths, so DOM concentration is analyzed by analyzing the decrease in reflectance at these wavelengths.

In addition, in water quality analysis using the MPP algorithm, water quality can be analyzed not only through multispectral data analysis but also through polarization data analysis. The reflectivity of polarized light on the water surface is affected by the size and concentration of particles in the water, and the shape and distribution of particles in the water are estimated and analyzed by analyzing polarization data. In addition, by analyzing the light scattering pattern by particles in the water, turbidity and particle concentration are analyzed more precisely.

Data that has gone through the analysis process is integrated. Multispectral data and polarization data are combined and analyzed to derive more precise analysis results. For example, by analyzing spectral data and polarization data of a specific wavelength together, the types and concentrations of particles in water can be identified and analyzed more accurately.

Data that has gone through the integration process are analyzed to derive results. Based on the analysis results analyzed by the MPP algorithm, the characteristics of the water are interpreted and results are derived. For example, whether the water color of a specific area is higher or lower than the preset standard value, whether the chlorophyll concentration is increasing or decreasing, etc. are analyzed and derived, and the analyzed data can be visualized in the form of a map or graph so that users can see the spatial changes at a glance.

In addition, the water quality environmental inspection unit (180) of the environmental inspection drone (2) can inspect water quality by collecting a water sample for inspection. To this end, the environmental inspection drone (2) can be equipped with a sampling unit for collecting a water sample. As shown in drawing (d) of FIG. 13, the sampling unit can be equipped at the bottom of the environmental inspection drone (2), and the sampling unit reaches the surface of the water in a specific area to collect water, lowers a hose from above, and inserts the hose into the water, and the hose inserted into the water moves water into the hose by the operation of a pump, and moves the water moved into the hose into the sample storage unit to store the water. The sample storage unit can be equipped at the bottom of the sampling unit, and the water collected by the hose moves through the hose connected to the pump and is stored in the sample storage unit.

The collected water can be analyzed on-site by the water quality environmental inspection unit (220) of the environmental inspection drone (2), and can be stored in the sample storage unit for more precise analysis and then sent to the central control center (1) for analysis at the central control center (1).

In addition, the sample storage unit may be configured with a plurality of sample storage units for storing the collected water samples, respectively, in order to store the water samples collected from the multiple inspection points or the same inspection point at different times. As shown in drawing (e) of FIG. 13, the sample storage unit may be configured with a first sample storage unit and a second sample storage unit, and the water samples collected from different inspection points may be stored respectively, and the water samples collected from the same inspection point at different times may be stored separately.

For example, when the water quality of a river needs to be tested, water samples can be collected from the upstream, middle, and downstream of the river. At this time, the water sample collected from the upstream of the river is stored in the first sample storage unit, the water sample collected from the middle stream is stored in the second sample storage unit, and the water sample collected from the downstream is stored in the third sample storage unit.

In addition, if you want to monitor water quality changes at the same location during morning, lunch, and dinner time periods, you can store water samples by time period as the temperature, pH, and concentration of pollutants of the water change over time. That is, the water sample collected in the morning is stored in the first sample storage unit, the water sample collected at lunch is stored in the second sample storage unit, and the water sample collected in the evening is stored in the third sample storage unit.

Additionally, the water sample stored in each sample storage unit is discharged outside to store a new water sample after the test is completed or after a certain period of time has elapsed.

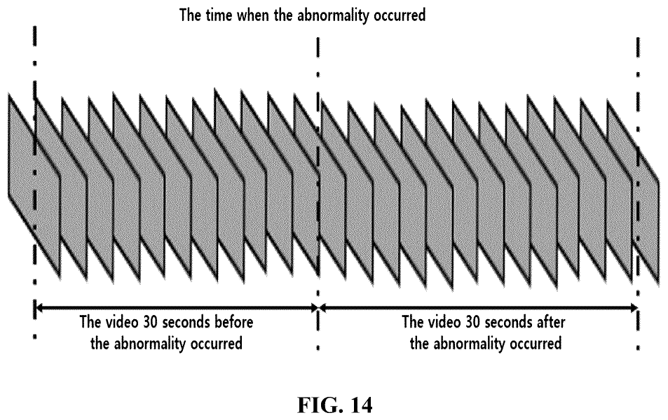

FIG. 14 is a drawing showing a process of inspecting images captured by a camera sensor before and after an abnormality occurs in an abnormality occurrence inspection unit of an environmental inspection drone according to one embodiment of the present invention.

Referring to FIG. 14, the sensor unit (145) of the environmental inspection drone (2) is equipped with a camera sensor (40) that photographs the surrounding environment of the environmental inspection drone (2). The camera sensor (40) is used for the environmental inspection drone (2) to photograph and transmit video or images in real time, and the camera sensor (40) is used in various ways, from a high-resolution camera sensor (40) to an infrared camera sensor (40), depending on how the environmental inspection drone (2) is utilized.

Each sensor of the sensor section (145) of the environmental inspection drone (2) detects that an abnormality has occurred in the environment while the environmental inspection drone (2) is conducting an environmental inspection. The shock sensor detects that an external shock applied to the environmental inspection drone (2) exceeds a preset reference value, the gyro sensor detects that the environmental inspection drone (2) is tilted exceeding a preset reference value, the acceleration sensor detects that the environmental inspection drone (2) is accelerated exceeding a preset reference value due to an external force, the altitude sensor detects that the environmental inspection drone (2) increases or decreases in altitude exceeding a preset reference value, the noise measurement sensor detects that the environmental inspection drone (2) makes noise exceeding a preset reference value, the camera sensor (40) detects that the screen is blurred exceeding a preset reference value, and the camera sensor (40) detects an abnormal phenomenon (e.g., flashing light, gas, smoke, etc.) that was not previously detected on the screen.

The abnormality detection unit (230) determines that an abnormality has occurred if the value detected by each sensor unit (145) exceeds a preset standard value.

In addition, if the abnormality occurrence inspection unit (230) determines that an abnormality has occurred, it acquires and analyzes videos taken by the camera sensor (40) equipped in the sensor unit (145) stored in the storage unit (140) for 30 seconds before and after the occurrence of the abnormality.

The environmental inspection drone (2) uses a camera sensor (40) to video the surrounding environment to inspect the environment before an abnormality occurs, and stores the video in the storage unit (140). In addition, the video stored in the storage unit (140) are periodically deleted if no abnormality occurs in order to secure the storage capacity of the storage unit (140). Through this, when the sensor unit (145) detects an abnormality, the abnormality occurrence inspection unit (230) acquires and analyzes videos 30 seconds before and after the time of the abnormality occurrence from the images stored in the storage unit (140).

In addition, the abnormality occurrence inspection unit (230) transmits a 30-second video before and after the abnormality occurrence time captured by the camera sensor (40) stored in the storage unit (140) to the central control center (1) and shares it with the central control center (1).

Meanwhile, if the occurrence of an abnormality and the cause of the abnormality are not found after analyzing the 30-second video before and after the time of the abnormality occurrence, the analysis time of the video can be increased from 30 seconds before and after (e.g., 60 seconds before and after or 90 seconds before and after) to proceed with the analysis. To this end, the abnormality occurrence inspection unit (230) secures the before and after videos for the increased time from the storage unit (140) as much as the time of the abnormality occurrence.

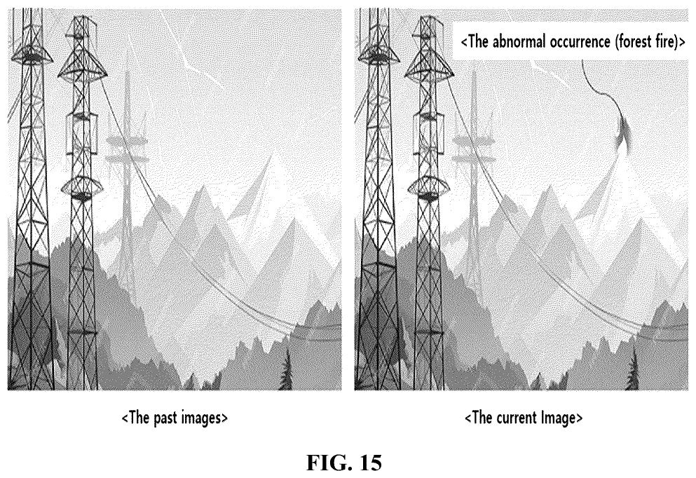

FIG. 15 is a diagram showing a process of comparing and analyzing a current image captured by a camera sensor of an environmental inspection drone according to one embodiment of the present invention with a past image stored in a storage unit to determine whether an abnormality has occurred and the cause of the abnormality.

Referring to FIG. 15, the abnormality occurrence inspection unit (230) or the central control center (1) of the environmental inspection drone (2) can compare and analyze the current image captured by the camera sensor (40) with the past images stored in the storage unit (140) to determine whether an abnormality has occurred and the cause of the abnormality.

For example, the abnormality detection unit (230) compares and analyzes past images and current images, and if it finds forest fires, flashes, gas, smoke, etc. that are not present in past images in the current image, it can determine that an abnormality has occurred.

In addition, the abnormality occurrence inspection unit (230) can determine that an abnormality has occurred if it compares past images with current images and discovers a specific subject (building, structure, etc.) that is not present in the past images. For example, if a drone monitoring a construction site sees a new building that was not present in the past images in the current images, it can determine that a new building has been created.

In addition, the abnormality detection unit (230) can compare past images with current images and determine that an abnormality has occurred if a specific subject (building, structure, etc.) that existed in the past image disappears. For example, if a drone monitoring a bridge discovers that a part of the bridge that existed in the past image has disappeared in the current image, it can determine that damage has occurred to the structure.

In addition, the abnormality detection unit (230) can determine that an abnormality has occurred by comparing the past image with the present image, and if the color of the present image of a specific object (e.g., a building, a mountain, the sky, a river, the sea) is different from the color of the past image. For example, if the color of a tree leaf is compared between the past image and the present image, and the tree leaf that was green in the past image has turned brown in the present image, the abnormality detection unit (230) can determine that an abnormality has occurred in the health of the tree due to damage from pests or drought. In addition, by comparing the color of water in the past image and the present image, if the water that was blue in the past image has changed to green in the present image, if the concentration of suspended matter has changed by measuring the transparency of the water, if the amount of phytoplankton in the water has changed, or if the amount of organic matter dissolved in the water has changed, the abnormality occurrence inspection unit (230) can determine that an abnormality has occurred in the water quality due to water contamination. In addition, if the color of the building in the past image and the current image are compared and the exterior wall of the building, which was gray in the past image, has changed to brown in the current image, the abnormality detection unit (230) can determine that the abnormality has occurred due to aging of the building.

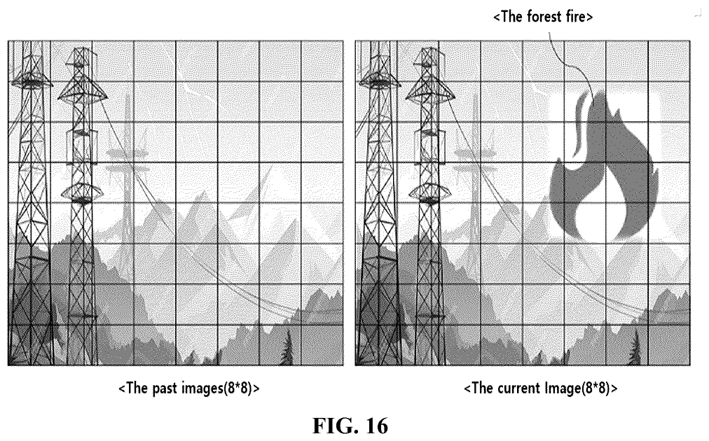

FIG. 16 is a diagram showing the process in which a camera sensor of an environmental inspection drone, according to an embodiment of the present invention, captures the current image, divides it in detail along with a past image stored in the storage unit, compares and analyzes them, and determines the occurrence of an anomaly and its cause.

Referring to FIG. 16, the abnormality occurrence inspection unit (230) can determine whether an abnormality has occurred by dividing a past image and a current image into details and comparing each of the divided detailed images.

The abnormality detection unit (230) compares past images with current images, and if the ratio of the detailed images in which changes have occurred in the segmented detailed images is 10% or more of the entire detailed images, it determines that an abnormality has occurred. In FIG. 16, since there are 64 detailed images, if changes occur in 7 or more detailed images, which is 10% or more of the 64, the control unit (150) determines that an abnormality has occurred.

The abnormal occurrence inspection unit (230) can set the number of image divisions differently depending on the current situation of the environmental inspection drone (2). For example, if the environmental inspection drone (2) is close to the subject of the environment being inspected, the image can be divided into fewer images. Conversely, if the environmental inspection drone (2) is far from the subject of the environment being inspected, the image can be divided into many images. In addition, if the pre-inspection result shows that the contamination level of the inspection environment is high (if the data value measured by the sensor unit (145) is higher than the standard value of the preset contamination level), the image can be divided into many parts in order to perform a precise inspection, and conversely, if the pre-inspection result shows that the contamination level of the inspection environment is low (if the data value measured by the sensor unit (145) is lower than the standard value of the preset contamination level), the image can be divided into fewer parts.

In addition, the abnormal occurrence inspection unit (230) can automatically adjust the number of image segments according to the changing surrounding conditions as the environmental inspection drone (2) moves. For example, the abnormal occurrence inspection unit (230) increases the number of image segments when the environmental inspection drone (2) moves close to the subject and then moves away from it. Conversely, when the environmental inspection drone (2) moves far from the subject and then moves closer to it, the number of image segments is reduced.

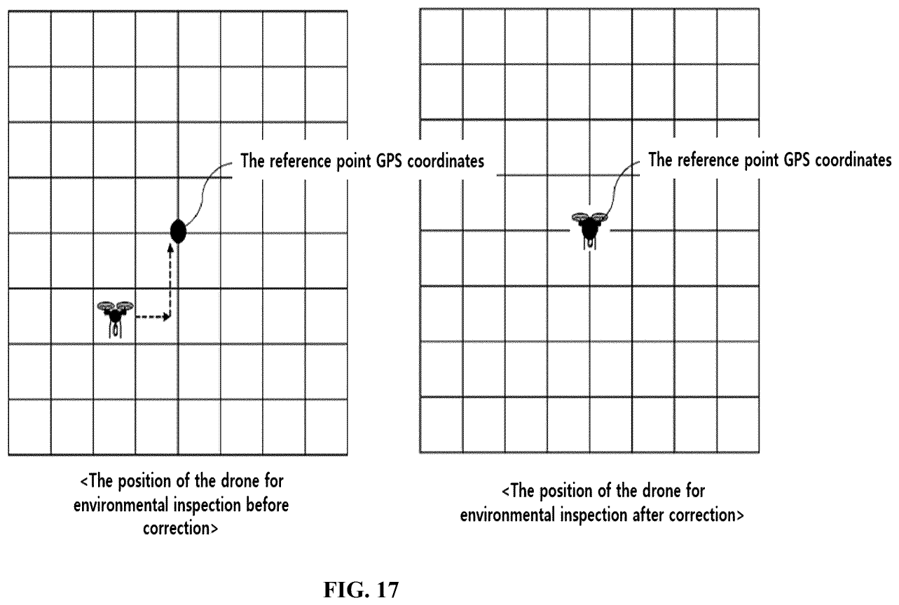

FIG. 17 is a drawing showing a process of setting and correcting an inspection position for an environmental inspection by an environmental inspection drone according to one embodiment of the present invention.

Referring to FIG. 17, the environmental inspection drone (2) moves along a preset movement path for environmental inspection, and when it arrives at a point where the environment (e.g., air, water quality, etc.) needs to be inspected, it conducts an environmental inspection.

At this time, the position measurement unit (170) of the environmental inspection drone (2) checks whether the point of arrival is the exact inspection point where the environmental inspection should be conducted before conducting the environmental inspection. If it is not the exact point where the inspection should be conducted, the position measurement unit (170) performs position correction to set the exact inspection point, and moves to the set inspection point to start the environmental inspection.

Through this, the environmental inspection drone (2) can repeatedly collect and analyze data from the same inspection point.

When the environmental inspection drone (2) arrives at the inspection point and performs the first environmental inspection at the arrived inspection point, the position measurement unit (170) stores the GPS coordinates of the area to be inspected in the storage unit (140). These GPS coordinates become the reference point for the environmental inspection as they are the same inspection point that the environmental inspection drone (2) repeatedly visits for environmental inspection.

When the environmental inspection drone (2) moves along a preset movement path and arrives at an environmental inspection point, the position measurement unit (170) obtains the GPS coordinates of the inspection point it has arrived at and compares the obtained GPS coordinates with the previously stored reference point GPS coordinates to determine whether it has arrived at the correct inspection point.

If the environmental inspection drone (2) has not arrived at the correct inspection point by comparing the previously stored reference point GPS coordinates with the acquired GPS coordinates, the position measurement unit (170) moves the environmental inspection drone (2) again by the amount of difference between the previously stored reference point GPS coordinates and the acquired GPS coordinates and corrects the position so that the environmental inspection drone (2) arrives at the correct environmental inspection point.

The position measurement unit (170) may additionally use other methods in addition to GPS coordinate comparison to ensure accurate arrival at the environmental inspection point.

The position measurement unit (170) can use the altitude sensor to check whether it has arrived at the height of the exact environmental inspection point. That is, the position measurement unit (170) uses both the GPS sensor and the altitude sensor to arrive at the exact environmental inspection point.

When the environmental inspection drone (2) arrives at the environmental inspection point using the GPS sensor, the environmental inspection drone (2) measures the current altitude of the environmental inspection drone (2) in real time using the altitude sensor equipped in the sensor unit (145). The altitude sensor continuously measures the altitude of the environmental inspection drone (2), and the position measurement unit (170) compares the measured altitude of the environmental inspection drone (2) with the preset reference point altitude to determine whether the environmental inspection drone (2) has reached the preset reference point altitude.

If the position measuring unit (170) determines that the environmental inspection drone (2) has not reached the reference point altitude, the altitude of the environmental inspection drone (2) is adjusted to continuously raise the environmental inspection drone (2) so that it reaches the reference point altitude, and if the position measuring unit (170) determines that the environmental inspection drone (2) has exceeded the reference point altitude, the altitude of the environmental inspection drone (2) is adjusted to continuously lower the environmental inspection drone (2) so that it reaches the reference point altitude.

In addition, the position measurement unit (170) can use the camera sensor (40) to check whether the environmental inspection drone (2) has accurately arrived at the environmental inspection point. The position measurement unit (170) compares the current image captured using the camera sensor (40) with the past images stored in the storage unit (140) to check whether the environmental inspection drone (2) has accurately arrived at the inspection point.

Before taking the current image, the position measurement unit (170) first checks whether the environmental inspection drone (2) is in a horizontal state using the gyro sensor and acceleration sensor provided in the sensor unit (145).

The current image must be captured when the environmental inspection drone (2) is in a horizontal state, so that accuracy can be improved when comparing it with the stored past images. Past images are vertical in the up-down direction and horizontal in the left-right direction, but if the current image is tilted, it may be difficult to accurately compare the current image and past images in a 1:1 correspondence.

For example, if the environmental inspection drone (2) was tilted slightly to the right when taking the current image, the tree would appear to be tilted to the right in the image even though it is actually upright. On the other hand, the past image was taken in a horizontal state and was saved as if the tree was upright, so the accuracy of comparing the current image and the past image on a 1:1 basis is low. As a result, the position measurement unit (170) may determine that it has not arrived at the correct location because the position or shape of the tree does not match when comparing the two images. Therefore, the position measurement unit (170) first checks whether the environmental inspection drone (2) is in a horizontal state before taking the current image.

When the position measurement unit (170) determines that the environmental inspection drone (2) is in a horizontal state, it captures an image of the surrounding area using the camera sensor (40). The captured image includes an image captured by the camera sensor (40) in a vertical downward direction from the position of the environmental inspection drone (2) and an image captured by the camera sensor (40) while the environmental inspection drone (2) rotates 360 degrees.

When the environmental inspection drone (2) arrives at the inspection point, the position measurement unit (170) captures an image in a vertical downward direction using the camera sensor (40). For example, if the environmental inspection drone (2) is located above a tree, the captured image includes the top of the tree, branches, leaves, and the shape of the ground around the tree.

In addition, the position measurement unit (170) utilizes a camera sensor (40) to capture images while the environmental inspection drone (2) rotates 360 degrees at the inspection point. The position measurement unit (170) positions the environmental inspection drone (2) so that it faces due south, and then uses the camera sensor (40) to capture images while the environmental inspection drone (2) rotates in a certain direction at a certain angle. For example, the position measurement unit (170) uses the camera sensor (40) to capture the surrounding environment while the environmental inspection drone (2) rotates clockwise at 5-degree intervals from the south direction. In order to improve accuracy, the angular interval at which the environmental inspection drone (2) rotates can be reduced, and in order to save inspection time although accuracy is reduced, the angular interval at which the environmental inspection drone (2) rotates can be increased. In addition, all captured images are stored in the storage unit (140).

Meanwhile, the position measurement unit (170) can compare the current image captured with the past image stored in the storage unit (140) to confirm whether the environmental inspection drone (2) has accurately arrived at the environmental inspection point.

The position measurement unit (170) can compare current and past images at all locations where images were taken to improve accuracy, and can compare current and past images at multiple specific locations to save inspection time, although accuracy may be reduced. Additionally, multiple specific locations can be arbitrarily selected by the location measuring unit (170). In addition, the position measurement unit (170) can continuously compare the current image with consecutive past images when comparing the current and past images.

Accuracy can be improved by continuously comparing the current image with consecutive past images (past images that were photographed at the same location but at different times).

Although the present invention has been described with reference to the above embodiments, it will be understood by those skilled in the art that various modifications and changes can be made to the present invention without departing from the spirit and scope of the present invention as set forth in the claims below.

### Description of the Sign

1: Central control center
2: Environmental inspection drone
10: First environmental inspection drone
20: Second environmental inspection drone
30: Third environmental inspection drone
40: Camera sensor
41: First support
42: Second support
43: Lens
A1: First environmental inspection drone inspection area
A2: Second environmental inspection drone inspection area
A3: Third environmental inspection drone inspection area
100: Drone server for environmental inspection
110: Input unit
120: Output unit
130: Communication unit
140: Storage unit
145: Sensor unit
150: Control unit
160: Memory unit
170: Position measurement unit
180: Inspection area setting unit
190: Inspection movement path setting unit
200: Inspection movement path storage unit
210: Atmospheric environment inspection unit
220: Water quality environment inspection unit
230: Abnormality occurrence inspection unit

1. An environmental inspection drone server, which is installed on an environmental inspection drone, includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
the memory unit includes a position measurement unit for measuring the location of the environmental inspection drone, an inspection area setting unit for setting an inspection area of the environmental inspection drone, an inspection movement path setting unit for setting an inspection movement path of the environmental inspection drone, an inspection movement path storage unit for storing the inspection movement path set by the inspection movement path setting unit, an air environment inspection unit for inspecting the air environment, a water quality environment inspection unit for inspecting the water quality environment, and an abnormality occurrence inspection unit for inspecting whether an abnormality occurs during an environmental inspection.

2. The environmental inspection drone server according to claim 1,
wherein the air environment inspection unit adjusts the interval between inspection points to be narrower or wider as set by the inspection movement path setting unit.

3. The environmental inspection drone server according to claim 2,
wherein the air environment inspection unit narrows the interval between the preset inspection points by adding an additional inspection point between adjacent inspection points as set by the inspection movement path setting unit.

4. The environmental inspection drone server according to claim 2,
wherein the air environment inspection unit widens the interval between the preset inspection points by allowing the environmental inspection drone to skip a specific inspection point without conducting an inspection and move directly to the next inspection point, as set by the inspection movement path setting unit.

5. The environmental inspection drone server according to claim 2,
wherein the air environment inspection unit pre-assesses the level of air pollution through a preliminary inspection and adjusts the interval between the preset inspection points to be narrower or wider accordingly.

6. The environmental inspection drone server according to claim 1,
wherein the air environment inspection unit adjusts the inspection time interval between the (n)th inspection and the (n+1)th inspection.

7. The environmental inspection drone server according to claim 6,
wherein the air environment inspection unit pre-assesses the level of air pollution through a preliminary inspection and, if the atmospheric data value measured by the air sensor included in the sensor unit exceeds a preset reference value, determines that the air pollution is severe and reduces the inspection time interval accordingly.

8. The environmental inspection drone server according to claim 6,
wherein the air environment inspection unit pre-assesses the level of air pollution through a preliminary inspection and, if the atmospheric data value measured by the air sensor included in the sensor unit is below a preset reference value, determines that the air pollution is not severe and increases the inspection time interval accordingly.

9. The environmental inspection drone server according to claim 1,
wherein the air environment inspection unit conducts a preliminary inspection and, among the inspection points set by the inspection movement path setting unit, if the data value measured by the sensor unit at a specific inspection point meets or exceeds a preset pollution level threshold, exceeds a preset temperature threshold, falls below a preset wind speed threshold, falls below a preset precipitation threshold, or exceeds a preset atmospheric pressure threshold, extends the inspection time at the specific inspection point.

10. The environmental inspection drone server according to claim 1,
wherein the air environment inspection unit conducts a preliminary inspection and, among the inspection points set by the inspection movement path setting unit, if the data value measured by the sensor unit at a specific inspection point is at or below a preset pollution level threshold, at or below a preset temperature threshold, at or above a preset wind speed threshold, at or above a preset precipitation threshold, or at or below a preset atmospheric pressure threshold, reduces the inspection time at the specific inspection point.

11. An environmental inspection drone server, which is installed on an environmental inspection drone, includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
The memory unit includes a position measurement unit for measuring the location of the environmental inspection drone, an inspection area setting unit for setting an inspection area of the environmental inspection drone, an inspection movement path setting unit for setting an inspection movement path of the environmental inspection drone, an inspection movement path storage unit for storing the inspection movement path set by the inspection movement path setting unit, an air environment inspection unit for inspecting the air environment, a water quality environment inspection unit for inspecting the water quality environment, and an abnormality occurrence inspection unit for inspecting whether an abnormality occurs during an environmental inspection, wherein:
the abnormality occurrence inspection unit determines that an anomaly has occurred if the value detected by the sensor unit exceeds a preset threshold and, secures and analyzes a 30-second video before and after the abnormality occurrence time, which is captured by the camera sensor included in the sensor unit and stored in the storage unit.

12. The environmental inspection drone server according to claim 11,
wherein the abnormality occurrence inspection unit secures and analyzes a 30-second video before and after the abnormality occurrence time, and if the abnormality is not detected, extends the video duration before and after the abnormality occurrence time for further analysis.

13. An environmental inspection drone server, which is installed on an environmental inspection drone, includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
The memory unit includes a position measurement unit for measuring the location of the environmental inspection drone, an inspection area setting unit for setting an inspection area of the environmental inspection drone, an inspection movement path setting unit for setting an inspection movement path of the environmental inspection drone, an inspection movement path storage unit for storing the inspection movement path set by the inspection movement path setting unit, an air environment inspection unit for inspecting the air environment, a water quality environment inspection unit for inspecting the water quality environment, and an abnormality occurrence inspection unit for inspecting whether an abnormality occurs during an environmental inspection, wherein:
the abnormality occurrence inspection unit determines the occurrence of an abnormality by comparing the current image captured by the camera sensor included in the sensor unit with the past image stored in the storage unit.

14. The drone server for environmental inspection according to claim 13,
wherein the abnormality occurrence inspection unit determines the occurrence of an abnormality by finely segmenting both the past image and the current image and comparing each segmented portion individually.

15. The drone server for environmental inspection according to claim 14,
wherein the abnormality occurrence inspection unit increases the number of segmented detailed images when the subject of the inspected environment is far away and decreases the number of segmented detailed images when the subject is close.

16. The drone server for environmental inspection according to claim 14,
wherein the abnormality occurrence inspection unit conducts a preliminary inspection and, if the data value measured by the sensor unit exceeds a preset pollution level threshold, increases the number of segmented detailed images, and if the measured data value is at or below the preset pollution level threshold, decreases the number of segmented detailed images.

17. The drone server for environmental inspection according to claim 14,
wherein the abnormality occurrence inspection unit compares each of the segmented detailed images, and determines that an abnormality has occurred if the ratio of the segmented detailed images in which a change has occurred to the entire segmented detailed images is greater than a certain ratio.

18. An environmental inspection drone server, which is installed on an environmental inspection drone, includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
the memory unit includes a position measurement unit for measuring the location of the environmental inspection drone, an inspection area setting unit for setting an inspection area of the environmental inspection drone, an inspection movement path setting unit for setting an inspection movement path of the environmental inspection drone, an inspection movement path storage unit for storing the inspection movement path set by the inspection movement path setting unit, an air environment inspection unit for inspecting the air environment, a water quality environment inspection unit for inspecting the water quality environment, and an abnormality occurrence inspection unit for inspecting whether an abnormality occurs during an environmental inspection, wherein:
when the environmental inspection drone arrives at the inspection point, the position measurement unit obtains the GPS coordinates of the inspection point at which it has arrived, and compares the obtained GPS coordinates with the previously stored reference point GPS coordinates to determine whether it has arrived at the correct inspection point.

19. The drone server for environmental inspection according to claim 18,
wherein the position measurement unit compares the obtained GPS coordinates with the previously stored reference point GPS coordinates, and if the environmental inspection drone has not arrived at the precise inspection point, corrects the position of the environmental inspection drone by the difference between the obtained GPS coordinates and the previously stored reference point GPS coordinates to ensure accurate arrival at the inspection point.

20. The drone server for environmental inspection according to claim 18,
wherein the position measurement unit measures the altitude of the environmental inspection drone and additionally determines whether the environmental inspection drone has arrived a preset reference altitude by comparing the measured altitude with the preset reference altitude.
